(19) United States
(12) Patent Application Publication
(10) Pub. No.: US 2017/0038031 A1
(43) Pub. Date: Feb. 9, 2017

(54) LED and/or Laser Light Device Has More Than One Optic Elements and wide flat opening or sphere outer cover to create big range image or lighted pattern

(71) Applicant: Tseng-Lu Chien, Walnut, CA (US)

(72) Inventor: Tseng-Lu Chien, Walnut, CA (US)

(21) Appl. No.: 15/296,599

(22) Filed: Oct. 18, 2016

Related U.S. Application Data
(63) Continuation-in-part of application No. 14/503,647, filed on Oct. 1, 2014.
Application No. 14/503,647 is a continuation-in-part of application No. 14/023,889, filed on Sep. 11, 2013.
Application No. 14/023,889 is a continuation-in-part of application No. 14/983,993, filed on Dec. 30, 2015.
Application No. 14/983,993 is a continuation-in-part of application No. 14/289,968, filed on May 29, 2014.
Application No. 14/289,968 is a division of application No. 14/280,865, filed on May 19, 2014.
Application No. 14/280,865 is a division of application No. 13/540,728, filed on Jul. 3, 2012, now Pat. No. 8,834,009.
Application No. 13/540,728 is a continuation-in-part of application No. 14/606,642, filed on Jan. 27, 2015.
Application No. 14/606,642 is a continuation-in-part of application No. 13/367,758, filed on Feb. 7, 2012, now Pat. No. 8,967,831.
Application No. 13/367,758 is a continuation-in-part of application No. 13/296,508, filed on Nov. 15, 2011, now Pat. No. 8,562,158.
Application No. 13/296,508 is a continuation-in-part of application No. 13/296,469, filed on Nov. 15, 2011, now Pat. No. 8,711,216.

(51) Int. Cl. F21V 14/00; F21V 7/00; F21V 23/06; F21S 8/00; F21V 11/00; F21V 5/00; F21V 5/04

(52) U.S. Cl. CPC F21V 14/00; F21V 5/00; F21V 7/00; F21V 5/04; F21S 8/035; F21V 11/00; F21V 23/06; F21Y 2115/10

(57) ABSTRACT

An LED or/and Laser light device(s) using outlet plug-in power source, or Bulb base power source, interchangeable power source or USB power source, which incorporates more than one geometric shapes optics elements or lens(es) that said optics lens(es) has one reflective or-and refractive properties which has relative positions, distances, and/or orientations to LEDs or/and Laser-light source(s) to let plurality of light beams reflect, retro-reflect or refract by reflector or refractor lenses, so the light beam(s) of the said LED(s) or laser-light(s) will reflective or/and refractive by traveling or passing though the said reflecting and refracting optic lens(es) to create or project image(s), message(s), number(s), time, geometric art(s), nature scene(s), galaxy(ies), milky way, sky(ies), cloud(s), space nebula, stars, moon, water-wave(s), aurora light(s), animal(s), character(s), cartoon(s), sign(s), logo(s), or commercial(s) to desired surfaces, including ceiling, walls, floors or all other desired areas with wider view angle image or-and lighted patterns. The said each of the said Optics lens and element(s) has its pre-determined texture, shaped opening, windows, cutout, variable thickness incorporate with motor/movement/spin/rotating/moving parts and accessories to make said above wide viewing angle image or lighted-patterns become motion/moving/variable/changing color or patterns.

The current invention are Continue Filing or Division filing for co-pending filing U.S. Ser. No. (# ZZZ-3) 14/503,647 filed date Oct. 1, 2014 which is Continue Filing for co-pending filing U.S. Ser. No. (# ZZZ-2) 14/451,822 filed date Aug. 5, 2014 which is Continue Filing for co-pending filing U.S. Ser. No. (# ZZZ-1) 14/323,318 filed date Jul. 3, 2014.

The current invention are Continue Filing or Division filing for co-pending filing U.S. Ser. No. (# QQQ-3) 14/983,993 filed date Dec. 30, 2015 which is Continue Filing for co-pending filing U.S. Ser. No. (# QQQ-2) 14/289,968 filed date May 29, 2014 which is Continue Filing for co-pending filing U.S. Ser. No. (# QQQ-1) 14/280,865 filed date May 19, 2014 (now allowanced) which is Continue Filing for co-pending filing U.S. Ser. No. (# QQQ-2012) 13/40,728 filed date Jul. 3, 2012 now is U.S. Pat. No. 8,834,009.

The current invention are Continue Filing or Division filing for co-pending filing U.S. Ser. No. (# MMM-1) 14/606,642 filed date Dec. 30, 2015 which is Continue Filing for co-pending filing US series number (# MMM-2012) 13/367,758 filed date Feb. 7, 2012 Now is U.S. Pat. No. 8,967,831.

The current invention are Continue Filing or Division filing for co-pending filing U.S. Ser. No. (# JJJ-1) 14/049,427 filed date Oct. 9, 2013 (now is U.S. Pat. No. 9,010,508) which is Continue Filing for co-pending filing US series number (# JJJ-2011) 13/296,508 filed date Nov. 15, 2011 now is U.S. Pat. No. 8,562,158.

| Application Number | Filing Date | Patent Number |
|---|---|---|
| 13-540,728 | Jul. 3^{rd} 2012 | U.S. Pat. No. 8,834,009 |
| 14-280,865 | May19 2014 | |
| 14-289,968 | May 29^{th} 2014 | |
| 13-367,758 | Feb. 7^{th} 2012 | U.S. Pat. No. 8,967,831 |
| 14-606,642 | Dec. 30^{th} 2015 | |
| 13-296,508 | Nov. 15th 2011 | U.S. Pat. No. 8,562,158 |
| 14-049,427 | Oct. 9^{th} 2013 | U.S. Pat. No. 9,010,508 |

### DESCRIPTION

### Background of the Invention

In the U.S. Market, there are a lot of desk top items consisting bulky shape and large sizes, these items often have optic elements and motor mechanics to show and project images or any information towards the wall or ceiling. However, all these items are overpriced and not technically compact enough to be a good item in this market. Also powered by limited power batteries for short using time.

(Feature 1)

The current invention is designed mainly to improve LED lights and/or laser lights devices that are meant to be projecting, showing, or creating image(s), message(s), number(s), time, geometric art(s), nature scene(s), galaxy(ies), milky way, sky(ies), cloud(s), space nebula, stars, moon, water-wave(s), aurora light(s), animal(s), character(s), cartoon(s), sign(s), logo(s), or commercial(s) with extra-small size and weight to allow users to be able to plug in any walls, ceilings, extension cords, power strips, USB power sources, or screw inside a bulb base.

Because plug-in outlet or USB means or bulb base can easily connect with the power source which Is not like the AC wired, Adaptor with wires, transformer with wire device which the wires are very difficult to handle to prevent people to fall down or damaged to get electric-shock. So the current invention doesn't prefer to use WIRED or batteries limited running hours' power source which will cause consumer fall down and also too risky for desk top installation so preferred for outlets plug-in or USB means but has no wired. Also, the current invention concerning the user's safety, this invention is preferred to be designed No wired design. Wire management can either be too clumsy to manage and clean or be too dangerous which might cause user to fall down by tripping on the wires. Due to this fact, this invention is preferred to be set up on wall outlets, plug in USBs, or bulb bases. The process of using this product on additional power options such as extension cord will work although not recommended.

This invention is designed to be used with USBs, bulb bases, or wall outlets. As an advantage, the invention will have unlimited resource, unlike anything on the market which operates under the power of batteries, alkaline batteries, this invention will not require any power option change to keep it working.

This invention will bring big improvements over any battery-operated items on the market.

(Feature 2)

The said moving or changeable optic element (such as stencil or optic-lens) incorporate the others optics-element (including optics lens) with changeable color, duration, function, cycles LED or LED(s) or-and laser light source can make the said LED or Laser light device become has more than one of the optics-elements device, so can increase the LED(s) or/and Laser-Light(s) performance, effect, functions including color change, size change, Motions, moving images or lighted patterns and all other light functions, performance available from market place and all combinations. Some preferred embodiment below will has 3.4.5 . . . optics means to form splendid light show.

This invention uses a traditional design which is rotating device or the motor, or inductive device (has magnetic & magnetic-coil assembly) or the silent clock movement to move the optical elements (with optics-lens or without the optics lens) and/or light sources, to perform the said effects such as moving, and projecting image(s), message(s), number(s), time, geometric art(s), nature scene(s), galaxy(ies), milky way, sky(ies), cloud(s), space nebula, stars, moon, water-wave(s), aurora light(s), animal(s), character(s), cartoon(s), sign(s), logo(s), or commercial(s). This invention was designed to have multiple optical element(s) (with optics-lens or without the optics lens) to cooperate with rotating device or motor or movement to create or to show a movable or changeable colorful and splendid image of lighted patterns or-and projection.

(Feature 3)

Furthermore, the current invention may use alternative design to create the moving or variable or changeable light effects no need to use the motor, or rotating or magnetic & magnetic-coil assembly is other alternative important improvement for cost consideration. I.E. The current invention as above discussion for alternative design for the said LED or/and Laser-light has changeable light functions with different timing for different functions, so it will be no any motor or rotating or spin or movement related device still can make the said changeable image, message, time, geometric art, nature scene, galaxy, milky way, sky, cloud, starts, moon, water waves, animal, characters, cartoon, sign, logo, commercial to been seen.

This invention also can uses alternative ways to create splendid image(s), message(s), number(s), time, geometric art(s), nature scene(s), galaxy(ies), milky way, sky(ies), cloud(s), space nebula, stars, moon, water-wave(s), aurora light(s), animal(s), character(s), cartoon(s), sign(s), logo(s), or commercial(s) by not using an inner-layer optical lens, but using a optics-elements (but not a lens) with holes, stencils, walls, openings, or cutouts to incorporate with the movable device to project or show a different effect that the is made out by the optics lens or convex optical lens would show.

(Feature 4)

The current invention big improvement to make all moving or motion effects are made by plurality of LED or-and Laser's sequential flashing, fade-in and fade-out, color changing, sequential, random, or other LED light performance, effects, performance, duration and use the each LED or-and Laser light source(es) with time difference, duration, on-off duty, cycles to turn on and turn off on different time and location and orientation to make the viewing image . . . etc to looking like moving.

One big improvement of this invention is the usage of different sequential patterns for the LED lights or-and laser lights such as fade-in and fade-out, flashing, color-changing, sequential, random, breathing, waves, etc. The above mentioned sequences are accompanied by another programming of time, duration, on-off duty, day time, orientation, location, and/or other cycling from IC Chip or elements to make the said projected and showed image to have motion, moving, changeable for color, patterns, size, effects.

(Feature 5)

More advanced improvement, the shaped image, message, time, geometric art, nature scene, galaxy, milky way, sky, cloud, starts, moon, water-wave, aurora light, animal, characters, cartoon, sign, logo, commercial can easily get from at least one or more than one of the optics element (with optics-lens or without optic-lens) which has its preferred texture, opening, cutouts, holes, shape, so can incorporated with refractive optics-lens to broad areas to be seen and incorporate with at least one of LEDs or/and Laser-lights' beam with rotating or non-rotating means to make the desired moon, stars, or moving aurora effects.

The invention can have variety of different image(s), message(s), number(s), time, geometric art(s), nature scene(s), galaxy(ies), milky way, sky(ies), cloud(s), space nebula, stars, moon, water-wave(s), aurora light(s), animal(s), character(s), cartoon(s), sign(s), logo(s), or commercial(s) due to the free ability to mix and match the optics-lenses from other Optics-element(s) has holes, stencils, walls, openings, or cutouts which also can be 2^{nd} optics-lens.

(Feature 6)

The current invention are Continue Filing or Division filing for co-pending filing U.S. Ser. No. 14/023,889 (# ZZZ) filed Sep. 11, 2013 and its continue filing U.S. Ser. No. 14/323,318 (# ZZZ-I) filed on Jul. 3, 2014 and (#ZZZ-2) U.S. Ser. No. 14/451,822 filed on Aug. 5, 2014.

both are the Continue filing U.S. Pat. No. 7,455,444 (More than one LED light source), U.S. Pat. No. 7,632,004 (More than one optic means), U.S. Pat. No. 8,277,087 (More than one reflective means to create multiple visible image). This also are (XX-2010) CIP filing for U.S. Ser. No. 12/938,564 Laser project which filed on Nov. 3, 2010 Now is U.S. Pat. No. 9,239,513 Jan. 19, 2016 issued.

The current invention are CIP of co-inventor's co-pending filing or following projection light device including:

U.S. Ser. No. 14/024,229 LED light has kaleidoscope means, Filed on September 2013.

U.S. Ser. No. 13/021,124 LED light has changeable image and pattern by kaleidoscope means to project to surfaces. Filed on Feb. 4, 2011 and public on Aug. 9, 2012, 2012-0200-828.

U.S. Ser. No. 12/710,918 LED light has more than one reflector means, Now U.S. Pat. No. 8,8277,087 which similar with current invention to apply the kaleidoscope means which has more than one reflective means hereof use mirror or mirror-like means to assembly into kaleidoscope means.

U.S. Ser. No. 11/806,284 LED light has more than one optic means, now U.S. Pat. No. 7,632,004 which has use more than one optics means which similar with current invention to apply the optics means in front of or back of back of kaleidoscope means to create, adjust, magnify, reduce, enlarge the said the said image, LEDs light beams, LED lights' image, shape which including the any combination from optics lens, optics mirror, laser hologram, laser grating film, optics assembly

U.S. Pat. No. 7,455,444 LED light has more than one LED light source, the current invention use more than one LEDs for matrix arrangements with Circuit means, IC means, sensor means, switch means, brightness control means, color mix means, color selection means, color freeze means, motor means, gear means, turn-On and turn-Off means to make the certain number of LEDs turn-On with desired color, brightness, light brightness output, light functions, matrix combinations, motor means, rotating means, gear set means to pass though the said kaleidoscope means, optics means, laser mans, motor means, gear means, to has desired light patterns.

U.S. Ser. No. 12/948,953, U.S. Ser. No. 12/938,564 U.S. Ser. No. 12/886,832, U.S. Ser. No. 12/876,507, U.S. Ser. No. 12/771,003, U.S. Ser. No. 12/624,621, U.S. Ser. No. 12/914,584, U.S. Ser. No. 12/318,471, U.S. Ser. No. 12/318,470, U.S. Ser. No. 12/834,435 and also is continuous filing for co-inventor's prior filing cases as below issued patents:

U.S. Ser. No. 12/292,153 (now is U.S. Pat. No. 7,871,192),

U.S. Ser. No. 12/232,505 (now is U.S. Pat. No. 7,832,917),

U.S. Ser. No. 12/318,473 (now is U.S. Pat. No. 7,832,918). LED light has laser means

U.S. Ser. No. 12/624,621 (Now is U.S. Pat. No. 8,303,150) LED project light for Seasonal items

U.S. Ser. No. 12/771,003 (now is U.S. Pat. No. 8,408,736) Light device has More than one project means.

U.S. Ser. No. 12/876,507 (now U.S. Pat. No. 8,083,377) Light device has projection function with focus adjustable and project means can change position

U.S. Ser. No. 12/886,832 Digital data projection Light device, Sep. 8, 2010 filed

U.S. Ser. No. 12/938,564 Laser projection light device, Nov. 4, 2010 filed, now is U.S. Pat. No. 9,239,513 issued on Jan. 19, 2016.

U.S. Ser. No. 12/948,953 LED light has time projection. Nov. 13, 2010 filed.

U.S. Ser. No. 13/021,107 LED light has 3Dimensional projection, Feb. 4, 2011 filed.

Above listed Projection light device total has (9) projection light device are parent filing cases as CIP filing of the current invention.

Further more the Co-invention also has co-pending filing for light device has interchangeable power source for Wall outlets AC power and Energy storage means (Direct current) including the all kind of combination selection from prong mean, extension cord, adaptor, transformer, Solar, wind power, Batteries, chemical power, biologic power all can be interchange or for any AC or battery power for Desk Top and Plug In type of current invention of project light device has build-in kaleidoscope means. The interchangeable co-filing cases as below:

U.S. Ser. No. 12/318,473,

U.S. Ser. No. 12/940,255 (Now U.S. Pat. No. 8,231,246) #FF-1

So the current invention are CIP for variety of co-inventor's co-pending or co-patents as above listed including: (1) Project light device (2) More than 1 optics means (3) More than 1 LEDs (4) More than 1 reflective means (5) Interchangeable power source (6) Laser Means (7) Adjustable focus and position changeable (8) motor & Gear set for moving adjustable.

This application has subject matter in common with U.S. patent application Ser. Nos. 12/710,561; 12/711,456; 12/771,003; 12/624,621; 12/622,100; 12/318,471; 12/318,470; 12/318,473; 12/292,153; 12/232,505; 12/232,035; 12/149,963; 12/149,964; 12/073,095; 12/073,889; 12/007,076; 12/003,691; 12/003,809; 11/806,711; 11/806,285; 11/806,284; 11/566,322; 11/527,628; 11,527,629; 11/498,874; 12/545,992; 12/806,711; 12/806,285; 12/806,284; 12/566,322; 12/527,628; 12/527,629; 12/527,631; 12/502,661; 11/498,881; 11/255,981; 11/184,771; 11/152,063; 11/094,215; 11/092,742; 11/092,741; 11/094,156. 11/094,155. 10/954,189; 10/902,123, 10/883,719; 10/883,747; 10/341,519; 12/545,992; and 12/292,580.

In particular, the following applications show light devices that have at least some features in common with included or optional features of the LED light device of the present invention: Ser. No. 12/710,561 (“LED power failure Light”); Ser. No. 12/711,456 (“LED light device has special effects”); Ser. No. 12/771,003 (“LED light device has more than 1 reflective means for plurality of image”); Ser. No. 12/624,621 (“projection device or assembly for variety of LED light”); Ser. No. 12/622,000 (“Interchangeable Universal Kits for all LED light”); Ser. No. 12/318,471 (“LED night light with pinhole imaging”); Ser. No. 12/318,470 (“LED night light with Projection features”); Ser. No. 12/318,473 (“LED night light with laser or hologram element”); Ser. No. 12/292,153 (“LED night light with Projection or imaging features”); Ser. No. 12/232,505 (“LED night light with Projection features”); Ser. No. 12/149,963 (“Removable LED light device”); Ser. No. 12/149,964 (“Surface Mounted Device with LED light”); Ser. No. 12/073,095 (“LED Track light device”); Ser. No. 12/073,889 (“LED light with changeable position with Preferable power source”); Ser. No. 12/007,076 (“LED light with changeable geometric system”); Ser. No. 12/003,691 (“LED light with changeable geometric dimension features”); Ser. No. 12/003,809 (“LED light with changeable features”); Ser. No. 11/806,711 (“Multiple LED light with adjustable angle features”); Ser. No. 11/806,285 (“LED Night light with outlet device”); Ser. No. 11/806,284 (“LED Night light with more than 1 optics means”); Ser. No. 11/527,628 (“Multiple function Night light with air freshener”); Ser. No. 11/527,629 (“LED Night light with interchangeable display unit”); Ser. No. 11/498,874 (“Area illumination Night light”); Ser. No. 11/527,631 (“LED Time piece night light”); Ser. No. 12/545,992 (“LED time piece Night light”); Ser. No. 12/292,580 (“LED Time Piece Night light”); Ser. No. 11/498,881 (“Poly Night light”); Ser. No. 11/255,981 (“Multiple light source Night Light”); Ser. No. 11/184,771 (“Light Device with EL elements”); Ser. No. 11/152,063 (“Outlet adaptor with EL”); Ser. No. 11/094,215 (“LED night light with liquid medium”); Ser. No. 11/094,215 (“LED Night light with Liquid optics medium”); Ser. No. 11/092,741 (“Night light with fiber optics”); Ser. No. 10/883,747 (“Fiber Optic light kits for footwear”); Ser. No. 11/498,874 (“Area Illumination for LED night light”); Ser. No. 11/527,629 (“Time Piece with LED night light”); Ser. No. 11/527,628 (“Multiple Function Night light with Air Freshener”); Ser. No. 11/806,284 (“LED Night light with more than one optics mediums”); Ser. No. 11/806,285 (“LED Night Light with multiple function”); and Ser. No. 11/806,711 (“Multiple LEDs Light with adjustable angle function”).

A preferred embodiment of the current invention includes an LED(s) or Laser-light(s) light has more than one optics means and each of optics means has passing though or reflective or/and refractive means within the geometric shape of the said optics means that provide a plurality of LED(s) or Laser-light(s) light beams to passing through or reflecting or/and refracting within the more than one reflector or/and refractive means inside the optics means.

The LED(s) or/and laser-light(s) device including at least one LED(s) or/and laser-light(s) arranged on the inner of the geometric housing has more than one of the said reflective or/and refractive optics-lens, and at least one of second optics-element(s) may is a 2^{nd} optics-lens within the geometric optics assembly which can reflect or refract LED(s) or/and Laser-light(s) light beam from its surface of light source to 1^{st} optics-elements (may is a optic-lens which has reflective or-and refractive surface(s) on back and forth surface), so some light beams been reflected or-and refracted or-and travel within the 1^{st} optics-element(s) and other some light beam are passing though the partial transparency optics means to 2^{nd} optics-lens which has refraction properties to make the light beams emit to outside and create a big range of viewing angle or cover big areas.

The LEDs or/and Laser-light(s) of these embodiment are preferably connected with circuit, power source, contact kits, conductive kits, switch, sensor, motor, movement, magnetic unit & coil assembly, spin, rotating kits, gear set, speed controller, printed circuit, integrated circuit (I.C.) and/or related parts and accessories to cause the LEDs or/and laser-light(s) to turn on and off according to a predetermined time period, functions, colors, and/or effects to provide a desired lighting performance.

In the above-described preferred embodiment, the reflective or/and refractive optics-lens may be a mirror-like polished surface, Optics lens, convex lens, concave lens, optics properties lens, chrome finished piece, polished piece, double-side mirror, or any surface in desired size, shape, thickness, focus, wide viewing angle which having reflective or refractive properties and let light beam can traveling or passing though both or more than one of the said optics lens suitable to the current invention.

The partial transparent, see-though properties and reflective or refractive features can be provided by a transparent piece, colored transparent piece, or any other pieces that allow light beams to pass there through or be reflected or refracted. A power source of those embodiment can be in the form of an outlet, batteries, solar power, chemical power, or wind power by proper connect at least for prong or Bulb-Base or USB means.

The LEDs or/and laser-light(s) can be selected from any combination of single color, multiple colors, multiple pieces, standard, special assemblies, and/or LED and Laser-Light number from 1 to N (N can be any number) to arrange in desire matrix, order, combination with proper spacing which available on the market.

Finally, the distance, position, orientation of the reflective or refractive optics-lens may be changed to the LED(s) or laser-light(s). The LEDs or Laser-Light(s) arrangement for different of LED or Laser-light number, position, color, IC chip, controller circuit, functions, and brightness and may selected to incorporate with the said motor/movement/spin/rotating/magnetic & coil assembly can create a desire plurality of light patterns, show, color changing, images changing, moving effects to people to be seen on surface(s) including walls, ceiling, floor, or desire surface(s).

The said geometric optic lenses can have any desired shaped with multiple constructions having different effects, the said geometric optic lenses can have any desired combination selected from the passing through lens, reflective lens, convex lens, concave lens, laser lens, hologram lens, desired focus, thickness, variable thickness, plurality of optics means, wave texture, desired texture, curvature, curve, optics properties on the inner optical element and/or on the outer optical element and/or on all sides of the surfaces to make a certained and desired lighting effects, projections, or effects.

From all the details above, this invention, having more than one built in reflective or refractive optical lens(es) or element(s), uses more than one geometric shape optical lens(es) or element(s) to create plurality or multiple LED lights and/or laser lights beams to pass through, reflect, retro-reflect, refract the said more than one optical lens(es) or element(s), the said optical lens(es) or element(s) may be selected to be incorporated with other electric parts and/or accessories to be able to project, create, or show a wider viewing angle image projection and/or image. The relative distance, position and/or orientation of the said optical lens(es) or element(s) to the light source (or any additional elements of it) will result in different light beam performances. This invention creates a simple way to make splendid, eye-catching, beautiful light show, performance, projection, and creation with the said wide viewing angle to cover a huge area, ceiling, wall, or any surfaces that are visibly easy to see but not limited to it. The other reason this invention is convenient to use is the said invention will operate under multiple commonly used power sources: USB power, outlet (prongs) power source, generator power, chemical power, solar power, magnetic power, wind power, and specially for the bulb base power, etc.

### BRIEF DESCRIPTION OF THE DRAWINGS

FIG. 1 is the 1^{st} preferred embodiment show the LED or-and laser light device has more than one optics-elements has the outer half ball, ⅔ ball, dome, or sphere 1^{st} optic-element which is optics-lens and has the inner geometric shape 2^{nd} optics-element which is other optics lens. Both has its pre-determined optics properties so can allow LED or-laser light beam emit out to big area or wider view angle to viewer.

FIG. 1A is the 2nd preferred embodiment show the LED or-and laser light device has more than one optics-elements has the outer around 180 flat wider opening cover is the 1^{st} optic-element which is optics-lens and has the inner geometric shape 2^{nd} optics-element which is not the optics lens but made by preferred material which may a plastic film, slide, film, printed sheet, image-forming carrier, shape-forming carrier, color film, piece has openings or cutouts or windows or shaped printed to make the LED or-and laser beam to pass though non-block areas to shape the light beam. The 2^{nd} inner optics-element can work with moving device to make the image or lighted patterns has moving, changeable effects. Both has its pre-determined optics properties so can allow LED or-laser light beam emit out to big area or wider view angle to viewer.

FIG. 1B is the 3rd preferred embodiment show the LED or-and laser light device has more than one optics-elements has the outer around 180 flat wider opening cover is the 1^{st} optic-element which is optics-lens and has the inner geometric shape 2^{nd} optics-element which is not the optics lens but made by preferred material which may a plastic film, slide, film, printed sheet, image-forming carrier, shape-forming carrier, color film, piece has openings or cutouts or windows or shaped printed to make the LED or-and laser beam to pass though non-block areas to shape the light beam.

FIG. 2 or FIG. 2A that disclosure the 2^{nd} optics-elements like those are dish like reflector has plurality small tiny reflector to build along the dish like surface. The 2^{nd} inner optics-element can work with moving device to make the image or lighted patterns has moving, changeable effects. It has the 3^{rd} optics-elements like nuts, core, ball with many cut surface surround the surface so can allow the bottom LED or-and LED light beam passing through to get plurality of light beams to hit the dish like reflectors to get splendid light effects with or without moving or motor device to rotating to create the moving effects. All those Three or two optics-elements has its pre-determined optics properties so can allow LED or-laser light beam emit out to big area or wider view angle to viewer.

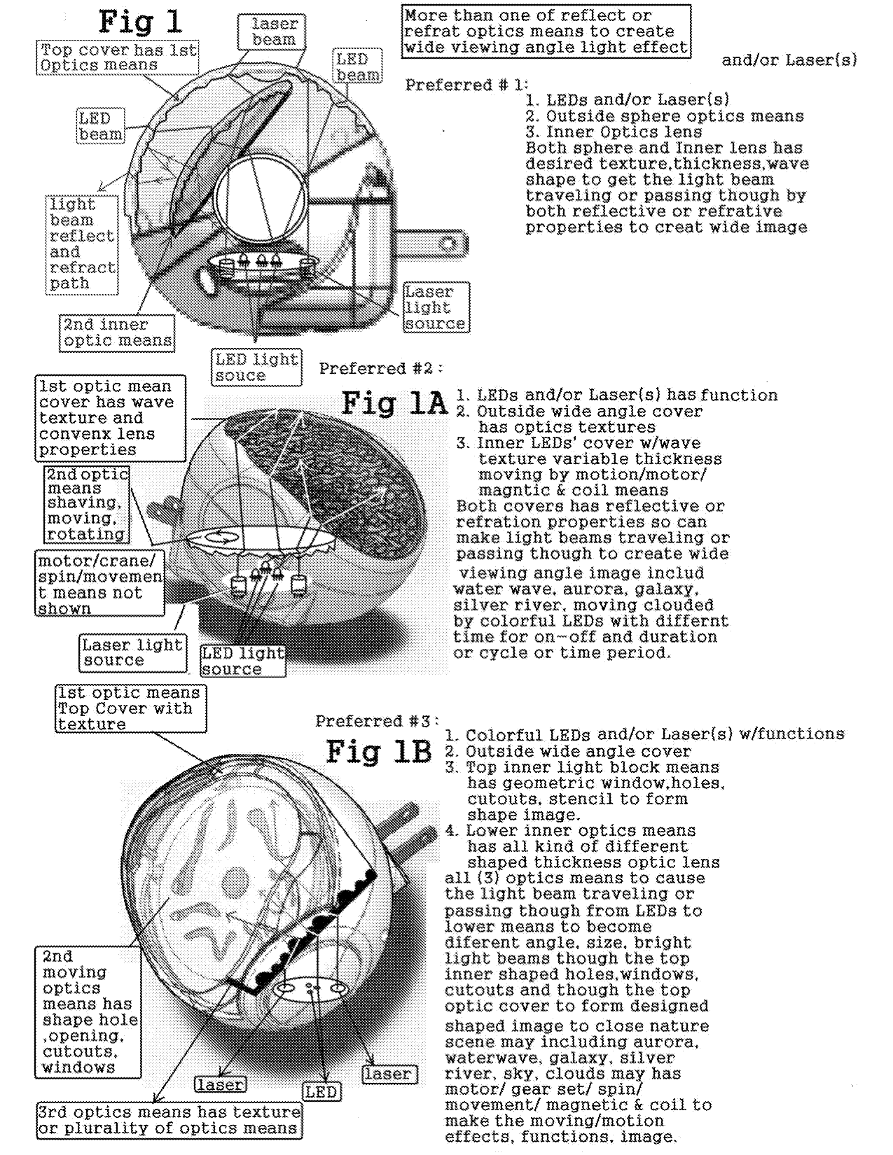

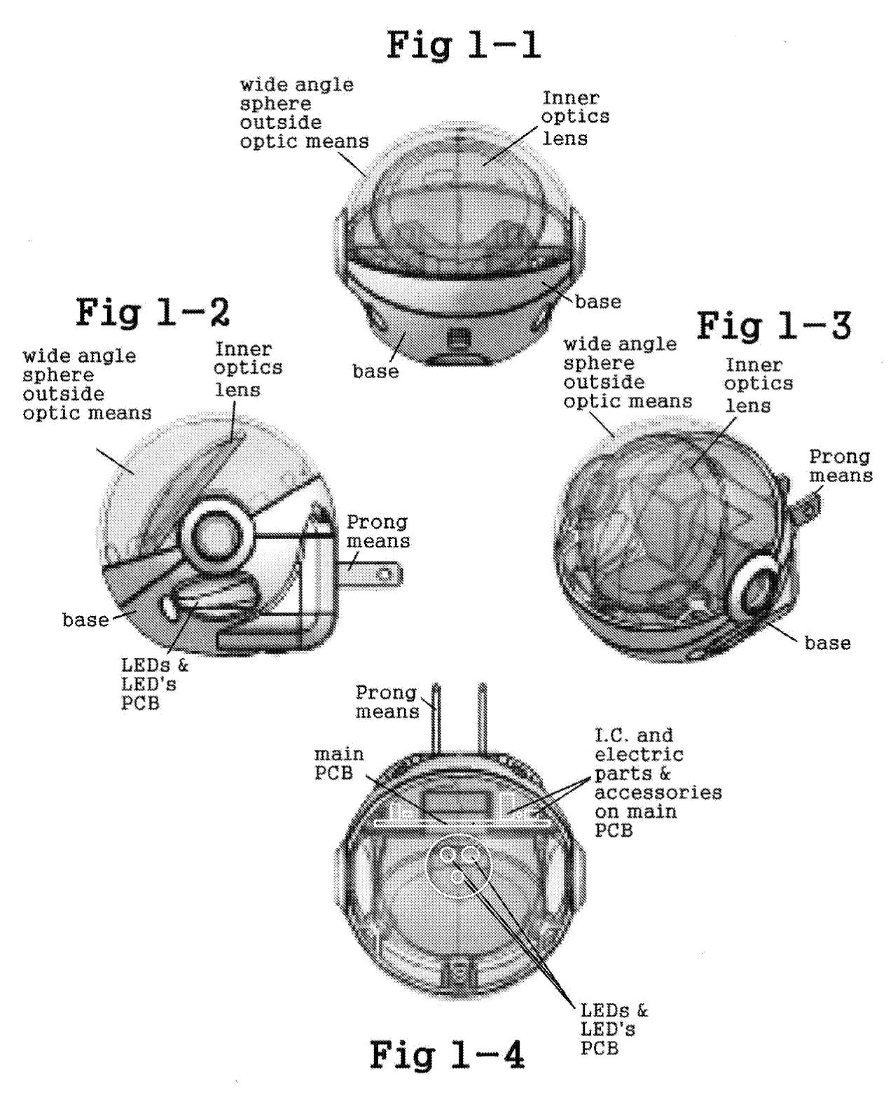

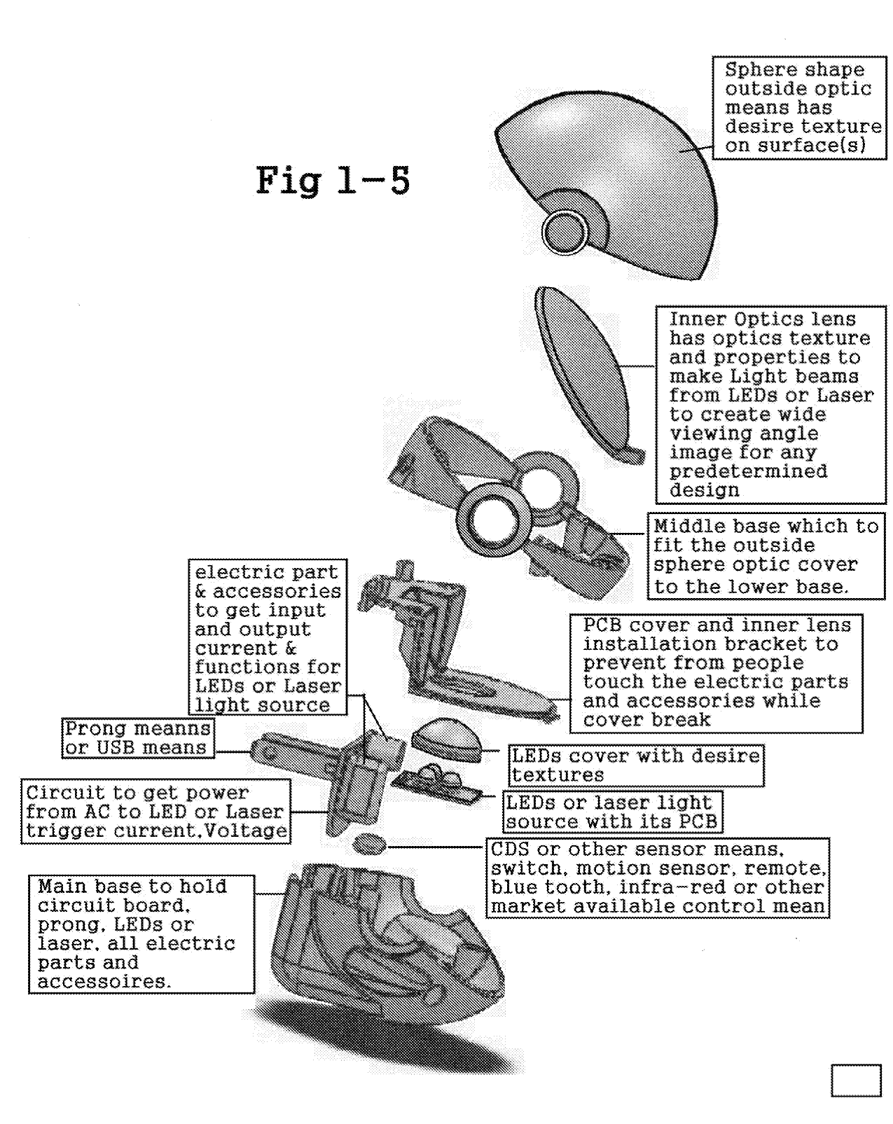

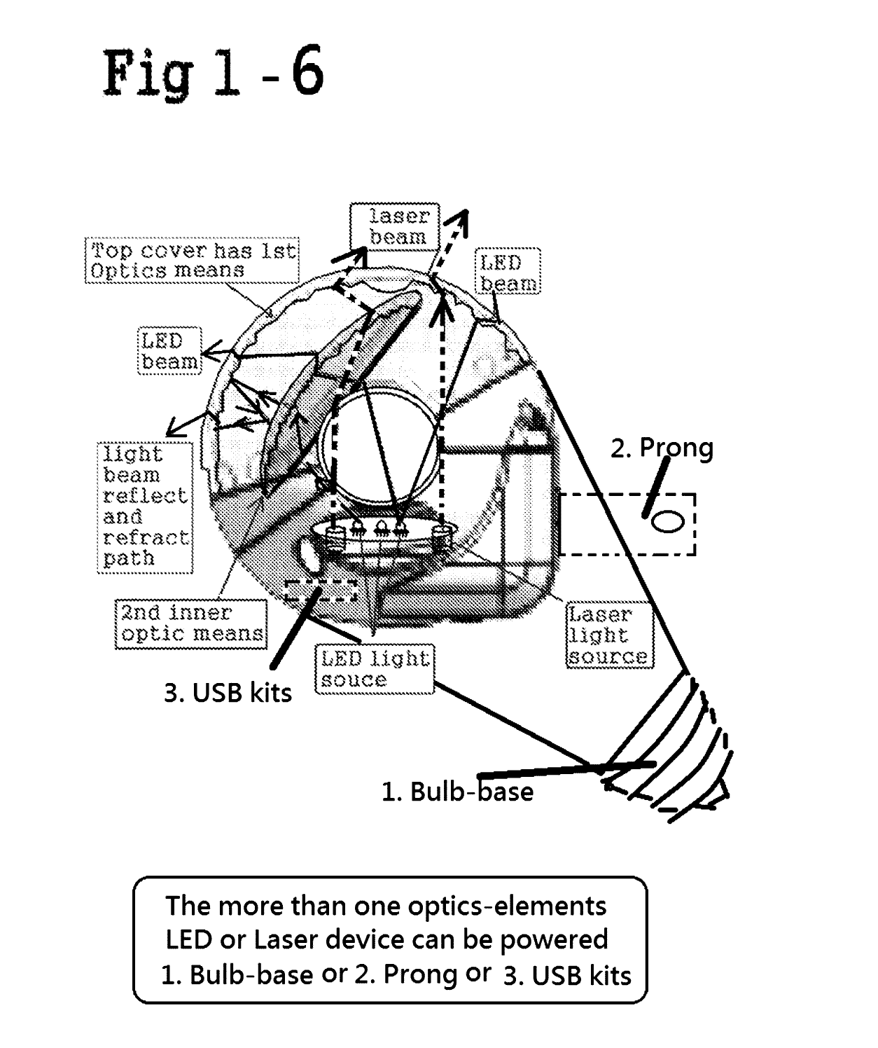

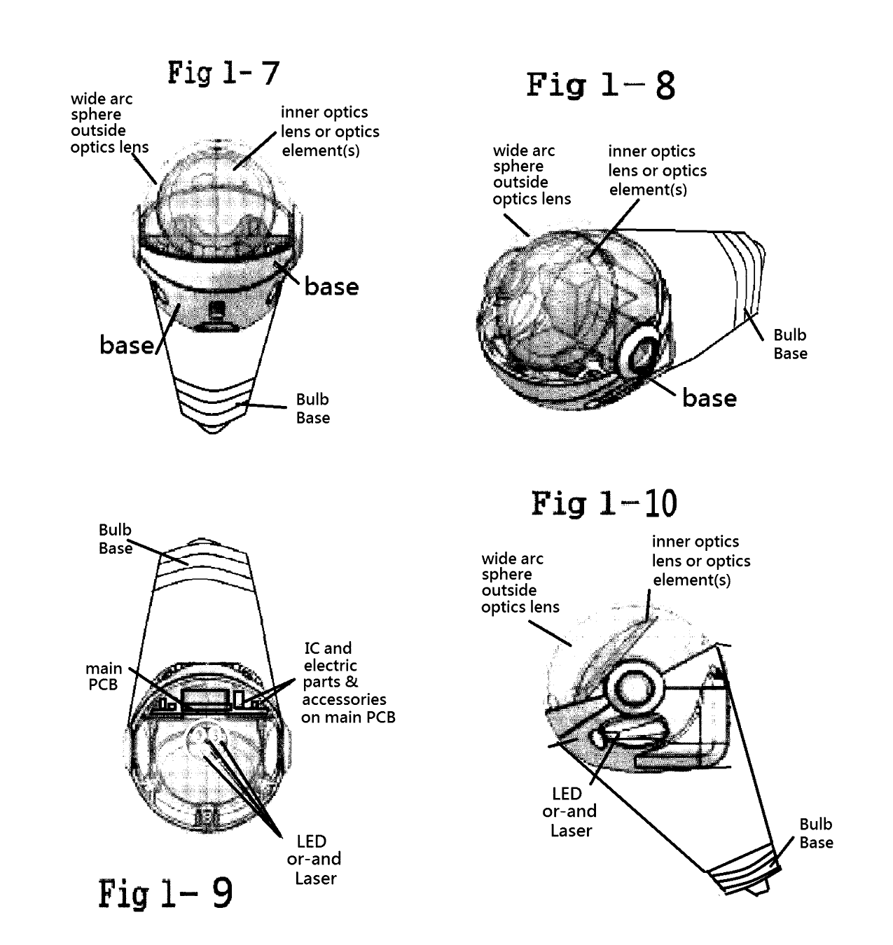

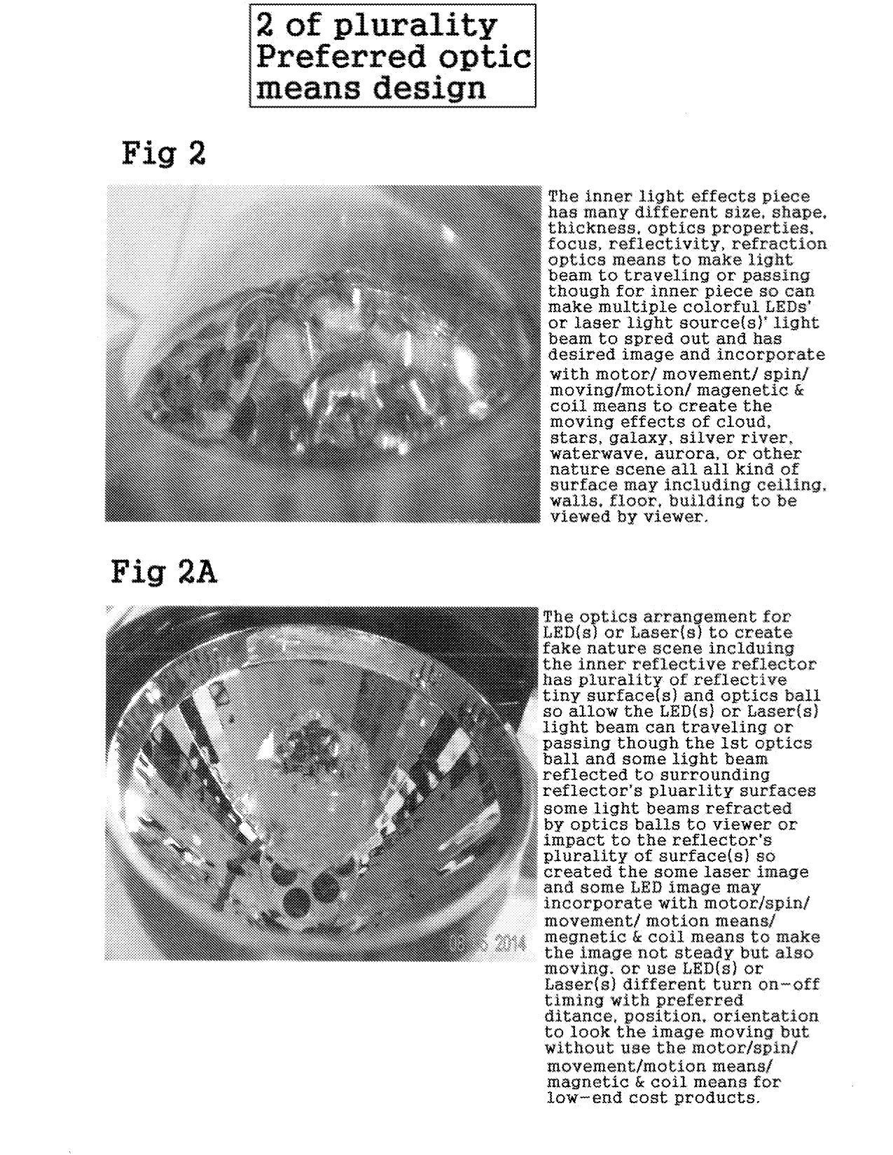

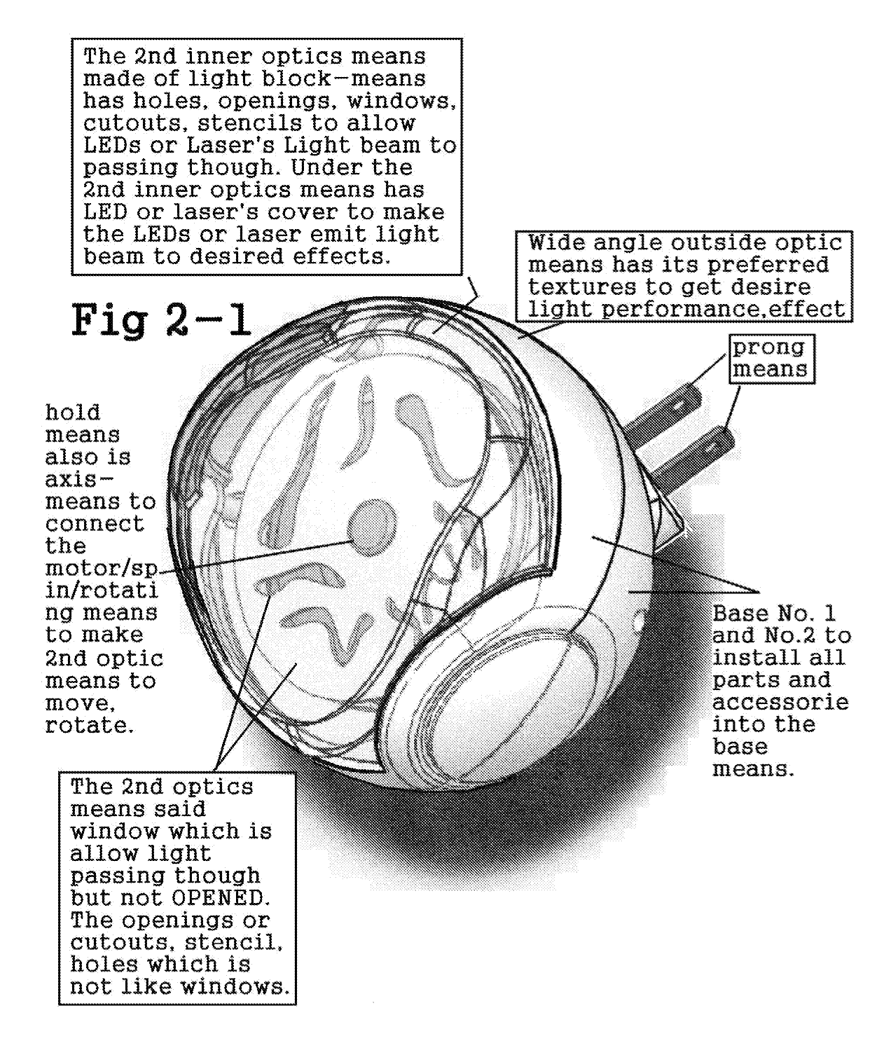

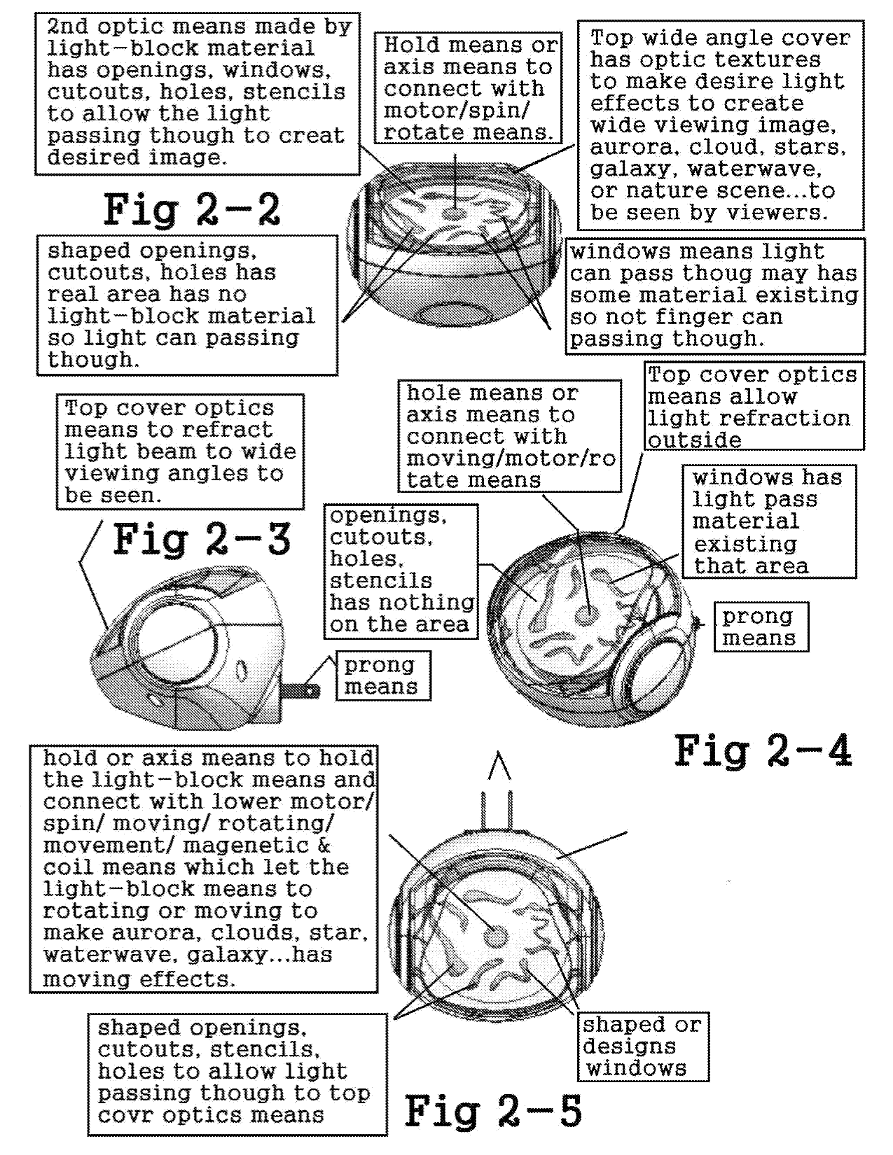

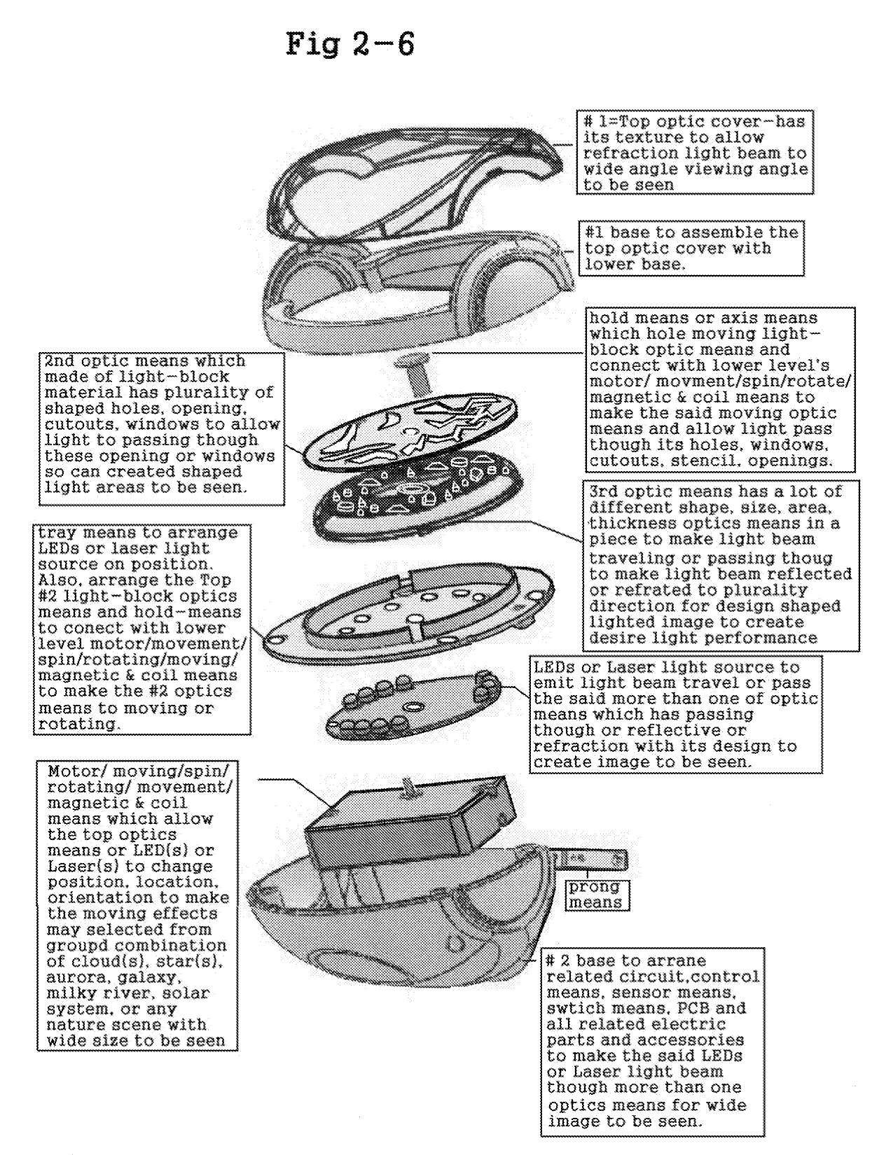

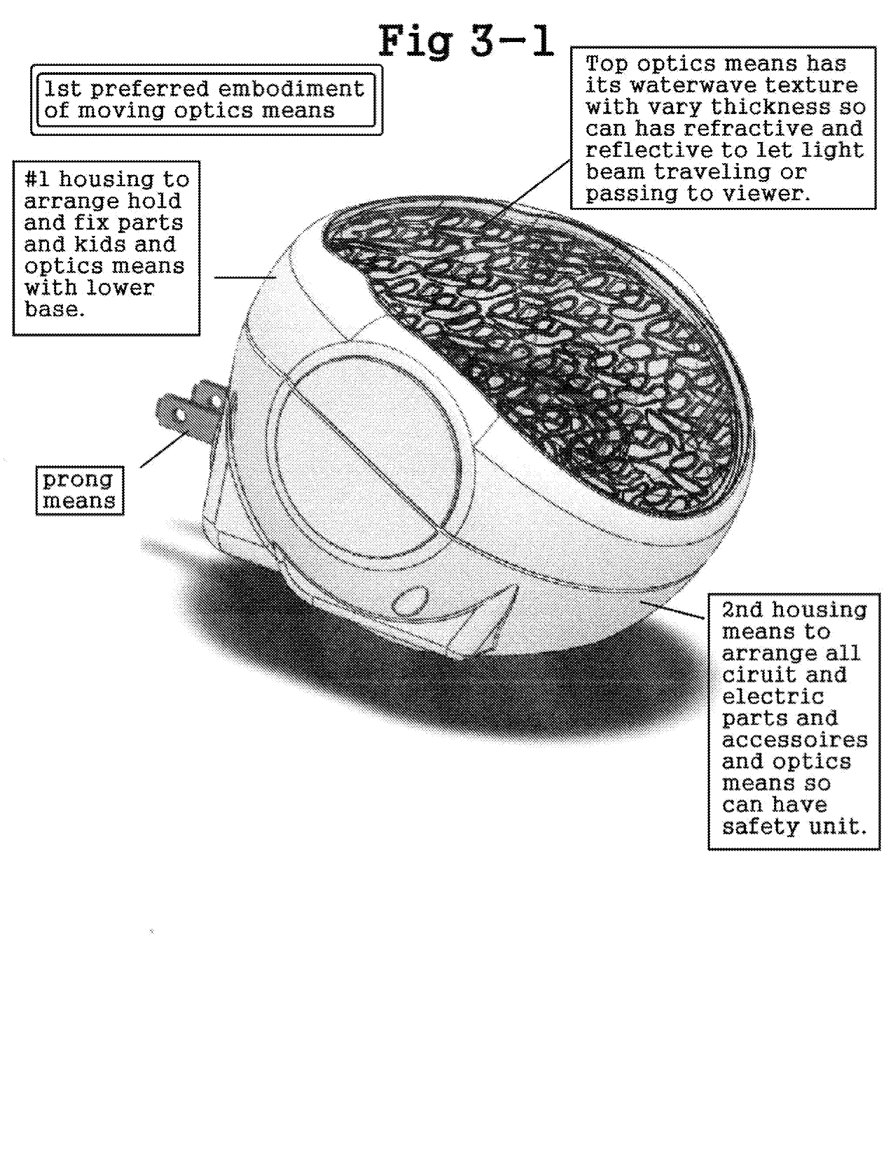

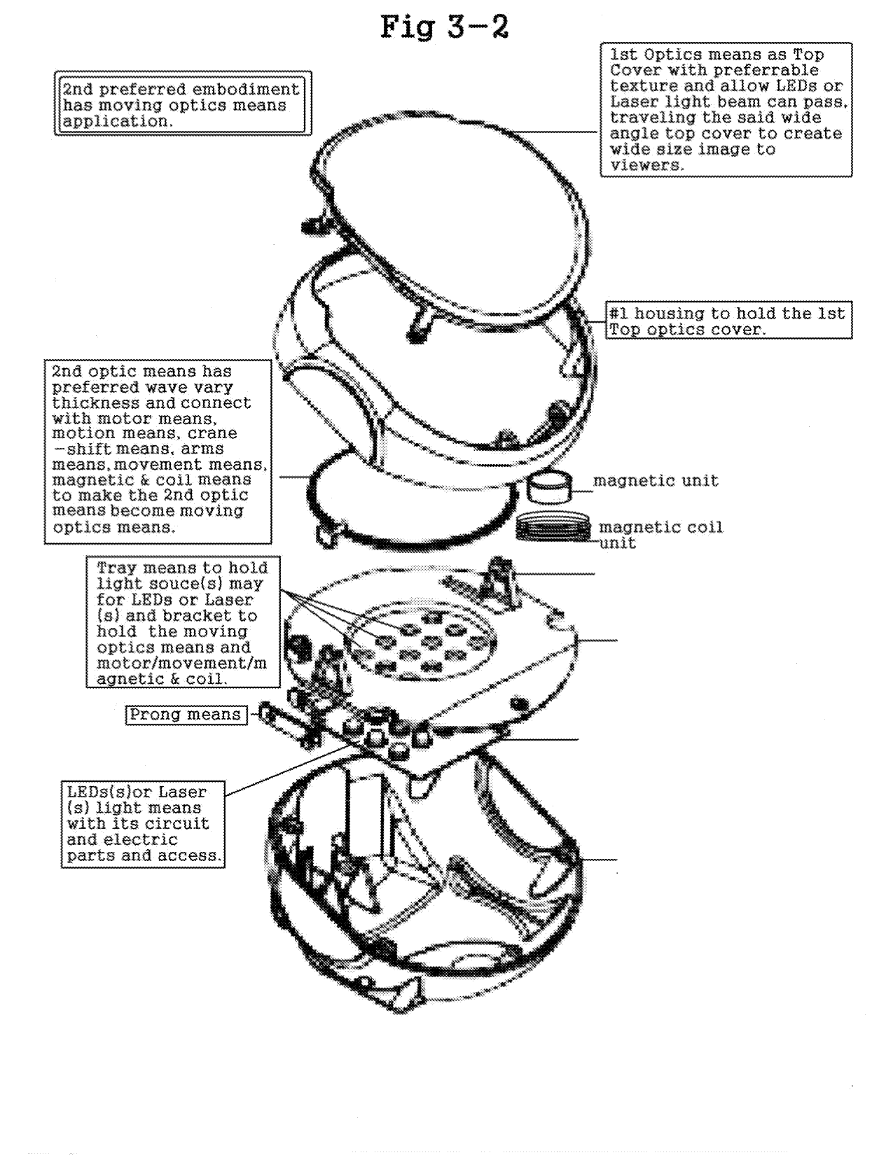

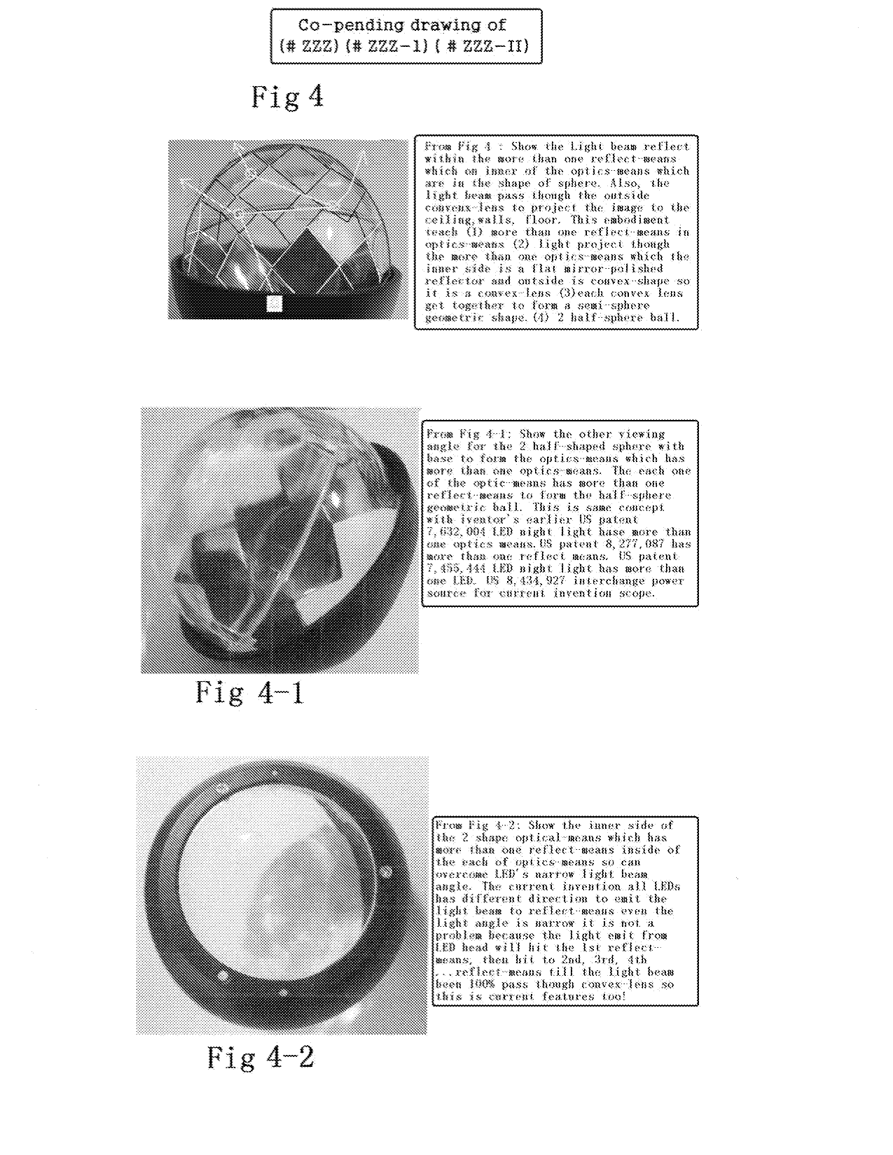

FIG. 1-1, FIG. 1-2, FIG. 1-3, FIG. 1-4 shown the 1^{st} preferable embodiment major 2 optics-elements and parts details. It also show 1^{st} embodiment incorporate the USB female port as FIG. 1-1 or incorporated with prong terminals such as FIG. 1-2, FIG. 1-3, FIG. 1-4.

FIG. 1-5 show the 1^{st} preferable embodiment all major parts construction with details BOM

FIGS. 1-6, 1-7, 1-8, 1-9, and 1-10 shows the alternative embodiment which uses different terminals to get the different power source such as bulb bases terminals to deliver the AC power into the Bulb-base for bulb-like LED or-and laser light products. Also show the Prong terminal to get the AC power or-and USB female ports to get DC power for original 1^{st} embodiment shape product. So as long as change the product shape can even had same optics parts & accessories to get AC power by Prong or the Bulb-base.

FIG. 2 and FIG. 2A show the inner optics-element can be a dish like reflector has plurality small tiny reflector to build along the dish like surface. The 2^{nd} inner optics-element can work with moving device to make the image or lighted patterns has moving, changeable effects. (Details shown aside the Figure)

From FIG. 2A, show Furthermore may has 3^{rd} optics-elements like nuts, core, ball with many cut-surface(s) surround the surface of nuts, core, ball, so can allow the bottom LED or-and LED light beam passing through to get plurality of light beams to hit the dish like reflectors to get splendid light effects with or without moving or motor device to rotating to create the moving effects. All those Three or two optics-elements has its pre-determined optics properties so can allow LED or-laser light beam emit out to big area or wider view angle to viewer. (Details shown aside the Figure)

FIG. 2-1, FIG. 2-2, FIG. 2-3, FIG. 2-4, FIG. 2-5 shown the 2nd preferable embodiment major parts details. (Details shown aside the Figure)

FIG. 2-6 show the 2nd preferable embodiment all major parts construction.

(Details shown aside the Figure)

FIG. 3-1 shown the 3rd preferable embodiment major parts details.

(Details shown aside the Figure)

FIG. 3-2 show the 3rd preferable embodiment all major parts construction.

(Details shown aside the Figure)

FIG. 4, FIG. 4-1, FIG. 4-2 show the one ½ ball or ⅔ ball or sphere or dome top cover optic-lens has multiple small size of reflective-surface(s) inside the ball and has multiple small size refractive-surface(s) on the outside surface to form a optic-elements has more than one of optics-properties.

### DETAILED DESCRIPTION OF THE PREFERRED EMBODIMENTS

FIG. 1 and FIG. 1A and FIG. 1B: shows 3 preferred embodiment of the current invention has prong and more than one optic element(s) to create wide viewing angle image. All of these embodiments has common parts including (1) Light source—LEDs or Laser—light(s) (2) Wider angle top cover (preferred for Optics-lens has refractive function) with its preferred optic properties (3) More than one of optics element(s) including inner 1^{st} one or inner more optics element(s) each may has plenty light passing or shape lighting or-and the reflective or refractive function build-in (4) Each optics element(s) has predetermined optics properties by making has different size, shape, thickness, variable thickness, height, cutout, stencil, window, silkscreened, or other assortment, arrangement, combination and the geometric optics-element may also has plenty of the convex-lens or concave lens or reflective tiny piece build in one optic reflector as 1^{st} one optics-element(s) all variable construction should be fall within the current invention scope. (5) the optics element(s) or light source (LEDs or/and laser-light) may incorporate with motor/spin/rotating/movement/magnetic unit & coil assembly to make the optical elements or light source to become moving optical-element(s) or light source to make the splendid light performance to has changeable image, lighted patterns, message, time, geometric art, nature scene, galaxy, milky way, sky, cloud, starts, mom, water waves, animal, characters, cartoon, sign, logo, commercial to been seen.

From FIG. 1 and FIG. 1A and FIG. 1B, the LED and/or laser-light device which has more than one optical element(s) including optics-lens(es) which reflective or refractive properties. These devices have plug-in type prongs to connect with outlets from a wall, an extension cord, a power station, or a desk lamp power station's outlet receptacle. The LED and/or laser light device creates the light images towards ceilings, walls, floors, grounds, and all other preferred flat and visible area, but not limited to these prefers. The top cover of said device, has a designated or waved or diffusion or refraction treatment with preferred thickness, is able to project and create said images or-and lighted patterns to be widen to a bigger space, area, location, or all said surfaces.

The optics-elements has more than one including but not limited for optics-lens which has convex or reflective or refractive or any combination of these optics properties' construction basing on the requirement. Hence, the current invention any light beam can traveling or passing through at least more than one geometric shape optics-element and the said light beam emit out from LED or-and laser-lights' head to hit the 1^{st} reflective or refractive optics-lens or other material optics-element(s), then, Hit 2^{nd}, 3^{rd}, 4^{th} . . . . Till the light beam are pass through to outside through the top cover optics-elements which preferred is optic-lens with refraction properties.

The optics elements has more than one number and can be an optic lenses or any kind of material that will change the directions of path of the lights coming from the LEDs or-and laser. Optical lens either has convex lenses with designed thickness or reflective/refractive lenses to increase light effects and incorporate with moving device to make the movement patterns of the lights, these lenses are not limited to be used as one, but can be used as any combination of market available optics-lens with different optics properties.

From FIG. 1 show the more than one of optics-element(s) including the Top cover is optics-lens and inner optics-elements also is an optics-lens with desired lens specification and optics properties. This 1^{st} embodiment shown the 2 optics-elements both are optics-lens. The Top cover optic-lens has textures or variety or variable thickness reflective or-and refractive design to make all incoming light beam to reflective or-and refracted traveling or passing though the top cover optics-lens to refraction to wider areas to viewer. The light beam emit from the below desired number and color and brightness LEDs or-and Laser-Light(s) to get the very splendid color, light sport, diffusion, variable pattern while incorporated with the said IC or movement device, motion unit to make the light effects has moving and color changing and exciting effects to view.

From FIG. 1A shown the more than one of optics-element which is Not Only including the Top Cover optics-lens with textures here prefer as wave textures, but also inner 2^{nd} optics-element is not optics-lens which is made of other preferred material with desired treatment including printed film, stencil, plastic sheet has opening, cutouts, shaped or windows incorporate with movable, shakable, waving, rotating, spin device(s) so can make the non-movable Light source including LEDs or/and Laser-lights light beam passing though the movable 2^{nd} optics-elements and its optics designs such as textures or plurality of wave shaped light beam go through the 1^{st} optics-lens multiple times of reflection or/and refraction so get the pre-designed light effects after the light beams come out from top cover optics-lens. This is the examples for 2 optics-elements one is optic lens as top cover and other is the other material's optic-elements which has it preferred shaped or film or slide or pre-shaped window or printed film or image-forming carrier on the optics-element to make the designed shape, image, characters, sign, slogan, words.

The light beam come out from 2^{nd} optic-elements which incorporate with moving device so the light beams has its moving effects and then hit the 1^{st} top cover optics-lens and its texture or optics designs will make multiple times reflection or/and refraction can make the light performance become motion waves effects or such as Aurora, moving clouds, changeable galaxy, moving stars, moving milky river or other nature scene can be produce under details design for inner 2^{nd} optics-elements with design-forming carrier or image-forming carrier which may is film, slide, LCD display, stencil, printed film . . . etc.

From FIG. 1B show the moving optics as FIG. 1A preferred embodiment which has more than one of optics-elements which has 3 optics-elements which has plurality of tiny reflective-lens to form a big reflector as FIG. 2 and FIG. 2A which has desired different size, shape, geometric shape, thickness, focus, colors and may incorporate with motor, spin kit, rotating unit, movement, magnetic unit & coil assembly, shaking unit, waving kits, crane-shaft to make the fixed LEDs or Laser-lights' light beam travel and passing through the lower 3^{rd} optical-unit which preferred is crystal-like ball or nuts to create a hundred of light beam to hit to 2^{nd} optics-element may is a moving or stady reflector which has plurality of small reflective lens arrange on a dish-like surface or 2^{nd} optic-element made by other material has shaped holes, windows, cutouts, opening means and light can be shaped to certain range such as aurora light shape, cloud shape, star shape, milky river, galaxy shape, then the light beam will hit to the 1^{st} optics-element which is a top cover optics-lens to enlarge light beam to spread out to wider viewing angle image to let viewers to see.

The FIG. 1, FIG. 1A, FIG. 1B shown detail drawing show all the light beam emits out from the lower position's LEDs or-and Laser-Light(s) traveling or/and passing though different 2^{nd} or 3^{rd} optic-elements to make some plurality of light beams or shaped light beams and hit the cover optics-elements which preferred is optic-lens. The current invention can create the perfect light effects which are very good design and cannot make by single Optics-property such as only reflective or only refraction to get such effects.

From FIG. 1, FIG. 1A, FIG. 1B The current invention shown the some optics-element(s) including
(1) Optic-lens has textures
(2) Optics-element made of other material has shape holes, opening, cutouts, window, stencil, film, slide, LCD display, wireless changeable images.
(3) Optics-element or Optic-lens is moving while incorporate with crane-shift, motor & axis, spin kit, rotating kits, clock movement, Magnetic unit & coil assembly.
(4) Optic-element is a geometric shape unit has plurality tiny reflective lens arranged for geometric shape surface with different shape, size, color, thickness, variable thickness into or form a one unit to get fixed LEDs or-and Laser-light light beam to plurality of light beams become very splendid and spread out light beam
(5) Optic-lens for dome, half ball, ⅔ ball or sphere shape Cover which has wide opening so can has wider viewing angle to make all light beams to spread out to wider and Bigger areas with said designed Image wanted with or without refractive optics properties.
(6) Optics-element made by preferred material such as plastic can be any shape such as sheet, piece, ball, half ball, dome, nuts, ⅔ ball, sphere, bar, cover or any other geometric shape with its preferred optic construction including texture, opening, window, convex lens, slide, film, character iamge, LCD display, magnify lens, variable thickness, variable focus by plurality of tiny optic-lens, reflective piece, refraction-lens has steady fixed or has moving, waving, shaking, vibration, rotating device to added features.
So these are the other features for the current invention from the above FIG. 1, FIG. 1A, FIG. 1B.

From FIG. 1 and FIG. 1A and FIG. 1B. It has alternative design to get desired light effects which just has more than one LEDs or/and laser-light(s) so can use LED or-and Laser light source has different time to turn on and turn off with desired cycle, duration and frequency so can make the lighting is changeable for color, brightness so look like the moving or variable light effects to save a lot of complicated assembly or cost by using the motor or movement.

The LEDs or/and laser-light(s) may selected from group of color, specification, size, functions, power, watt, and each LED or/and laser-light(s) can has its emit direction, orientation, angle to anywhere while the inner has more than one reflective lens as inventor's prior patented claims so the each LED or/and laser-light(s) device has different light emit direction even LED or/and laser-light emit angle is narrow but after the light beam been under may reflected or/and refracted then, the light will come out from its wide opening cover including 180 flat, dome, ½ ball, ⅔ ball, sphere or dome shape cover so can get the wider viewing angle image or lighted patterns shown on desired sides, areas, surface.

This is the result basing (1) More than one LEDs or laser-light(s) (2) More than one Reflect or Refractive optics-lens or units (3) more than one optics-elements with desired optic properties (4) Selected incorporate with other parts & accessories may in desired combination selected from motor, movement, magnetic unit & coil assembly for inductive control the optic-lens waving, Interchangeable power source, moving optics-elements, optic-element made of light-block material has shaped holes or opening or windows, texture lens, optics lens, plurality of optics lens, IC, power source . . . etc. which may use all inventor's co-pending prior arts scope as inventor's all prior patents and co-pending all LED project light concept as above and below listed (9) co-pending and issued Prior arts.

Ser. No. 12/318,471, U.S. Ser. No. 12/318,470, U.S. Ser. No. 12/834,435 and also is continuous filing for co-inventor's prior filing cases as below issued patents:

U.S. Ser. No. 12/292,153 (now is U.S. Pat. No. 7,871,192),

U.S. Ser. No. 12/232,505 (now is U.S. Pat. No. 7,832,917),

U.S. Ser. No. 12/318,473 (now is U.S. Pat. No. 7,832,918). LED light has laser means

U.S. Ser. No. 12/624,621 (Now is U.S. Pat. No. 8,303,150) LED project light for Seasonal items

U.S. Ser. No. 12/771,003 (now is U.S. Pat. No. 8,408,736) Light device has More than one project means.

U.S. Ser. No. 12/876,507 (now U.S. Pat. No. 8,083,377) Light device has projection function with focus adjustable and project means can change position

U.S. Ser. No. 12/886,832 Digital data projection Light device, Sep. 8, 2010 filed

U.S. Ser. No. 12/938,564 Laser projection light device, Nov. 4, 2010 filed

U.S. Ser. No. 12/948,953 LED light has time projection. Nov. 13, 2010 filed.

U.S. Ser. No. 13/021,107 LED light has 3Dimensional projection, Feb. 4, 2011 filed.

Above listed Projection light device total has (9) projection light device are parent filing cases as CIP filing of the current invention.

From FIG. 1 and FIG. 1A and FIG. 1B show the Plug-In type light device with base are install on the Plug-In housing to make the Alternative Current (A.C.) to drive the inner circuit, LEDs or/and laser light, Sensor, switch, controller or wireless controller, and optional motor to make the moving optics-element including but not limited for optic-lens so can make motion effects of the related image to ceiling/walls/floor has plenty of color and moving (If add the motor or moving device).

The Said geometric shape optics-element(s) has more than one reflective or refractive or shape the light beam properties for the current FIG. 1 and FIG. 1A and FIG. 1B for all the said optics-elements of LED or-and laser light device.

The said LED or-and Laser light which preferred has the sphere or ball or half ball or ⅔ ball or dome or around 180 degree flat wide opening lens as top cover optics-lens has desired of optics-lens with desired optics properties including magnify and diffusion or spread out the light beams by (1) mirror-polished reflective or refractive lens for outside or inside and has (2) round convex surface outside of each optics-lens so it become a convex-lens so it will be not only can reflect the light beams also can allow light beam refraction and pass through to 180 degree wide opening flat cover or dome cover or sphere cover so the wider 180 degree flat opening or dome or sphere or half-ball or ⅔ ball Cover optics-lens is needed for current invention.

It is appreciated that the non-shown details for the Alternative Current (A.C.) type power unit has receptacle to receiving transformer, adaptor or AC wires. Adaptor or AC wires to drive the circuit to make the light source(s) turn on and emit light beam to desire area(s). It also can use USB wire to get power from the USB Ports.

From FIG. 1-6, FIG. 1-7, FIG. 1-8, FIG. 1-9, FIG. 1-10 It also can have the LED or-and laser light device has the Bulb-like shape housing and bulb-base as current delivery terminals to get AC power instead for Prongs application which always located on lower position. The Bulb-like shape device has bulb-base will be always on higher location for people to use is other current inventions features. These common skill can use from market place.

From FIG. 1 and FIG. 1A and FIG. 1B shows light device its optic-element has more than one reflective or refractive on its surface within one optics-lens to allow light beam can traveling or pass though the convex-lens especially for the TOP Cover Optics-element and reflect within the reflective-lens or refractive lens (2 in one piece) to let light emit out to create image on ceilings, walls, floor, so the more than one of optics-elements also including the one piece of lens has more than one optic-properties.

FIG. 1-1 and FIG. 1-2 and FIG. 1-3 and FIG. 1-4: shows a first preferred embodiment of the current invention has (2) Optics elements—one is top cover is optic-lens with refractive or-and reflective properties and one is inner disc-like optics-lens has refractive or-and reflective properties or convex lens both has the preferred wave-textures has variable thickness so the LEDs or Laser-Lights some of the light beam can passing though the disc-like optics-lens has wave textures then has 1^{st} lighted patterns or image and all these 1^{st} group light beam will traveling or passing the 2^{nd} Big and Wide optics-lens to create the Super large size viewing angle image, lighted patterns, message, time, geometric art, nature scene, galaxy, milky way, sky, cloud, starts, moon, water waves, animal, characters, cartoon, sign, logo, commercial to been seen.

From FIG. 1-1 show the current invention for 1^{st} embodiment which can get the AC power from different housing design from AC prong, AC bulb base or get the DC power from DC USB female port. The prong and Bulb base and USB female ports all only need to have Positive and negative current connect to 2 prong or 2 terminal of bulb base or 2 end of the USB female terminal so the current invention can have different shape of products but with same optics application for Prong unit, Bulb base unit, USB port unit only different only at the power input terminal design as FIG. 1-1 to FIG. 1-4 for prong and FIG. 1-7 to FIG. 1-10 for bulb base unit. The FIG. 1-6 show same optics arrangement but different terminals including prongs, bulb base, USB female ports.

From FIG. 1-1 and FIG. 2-4 Show no prong on drawing which may get the Direct Current (DC) by the USB female ports so these can be DC power unit which can have power from any Direct current device such as batteries, energy storage means, solar power, wind power, chemical power.

It is appreciated for the Interchangeable power source as the inventor prior art as above listed patent U.S. Pat. No. 8,434,927.

FIG. 1-5 shows the First embodiments details construction.

FIG. 1-6 shows the 2^{nd} preferred embodiment of the current invention which is using a bulb base as power supply. This figure symbolizes this invention can be powered up using many different ways such as, as shown in FIG. 1-6, a bulb base, prongs, or USB kits. FIG. 1-6 also shows the inner design which consists LED lights or-and laser lights (pattern shown as full lines and dotted lines) that are passing through the said 1^{st} optics-element which maybe a convex lens and the 2^{nd} optics-elements which may be a 2^{nd} optic-lens which has refractive properties to enlarge and spread out the light beam emit out from 1^{st} optics-element here preferred is convex lens to the outer lens (sphere) which are used for reflection and refraction. FIG. 1-6 also shows the replace of prongs by the shaped housing which has bulb base (making this product a bulb), or it can be other or alternative to get power from the USB port.

From FIG. 1-6 show the same optics-elements and same optics-application can fit for different shape of the product may has different terminals to get the power. The FIG. 1-6 show the unit has prong which same as the FIG. 1, FIG. 1-2, FIG. 1-3, FIG. 1-4 so can plug into the outlet device on wall or power strips or desk top power station. While it incorporated the bulb-base it can simple to change the product housing shape to bulb-like shape and the 2 power terminals can easily to connect on the bulb base wall for one pole and bulb base bottom for 2^{nd} pole which will has total same optics parts & accessories with the prong products. Furthermore while people would like to use USB female ports to connect with power source by USB wires, it is simple just add one USB female port on FIG. 1, FIG. 1-1 to FIG. 1-4 housing so can instantly can power by the Prong or the USB female ports by AC current (for Prong Product) and DC current (for USB female port) which only need change the inner circuit not even touch the Same optics parts & accessories.

FIGS. 1-6, 1-7, 1-8, 1-9, and 1-10 shows the 2^{nd} preferred embodiment of the current invention which shows this invention to have (2) Optic elements: top cover on the outside, and inner disc-like convex lens. The said (2) optic elements both have preferred textures and designs (wave-like) to vary the thickness of the lens so the said LED lights or laser-lights can pass through the inner disc-like convex lens which hasta designed thickness or texture (wave-like), or lights can pass through alternative elements of optical lens(es), such as holes, stencils, walls, openings, or cutouts to project and show figures FIG. 1A and FIG. 1B without using an optical lens that has designed thickness, then pass through the outer optic element has refractive properties so can enlarge and spread out the light beam which widens the created or projected image(s), lighted patterns, message(s), number(s), time, geometric art(s), nature scene(s), galaxy(ies), milky way, sky(ies), cloud(s), space nebula, stars, moon, water-wave(s), aurora light(s), animal(s), character(s), cartoon(s), sign(s), logo(s), or commercial(s). FIGS. 1-6, 1-7, 1-8, 1-9, and 1-10 also shows the preferred embodiments on different power source housings such as corn-like bulb housing has bulb base; possible for many shape of the bulb available from market place and bulb bases such as e12, e17, e26, etc.

From FIGS. 1-7, 1-8, 1-9, and 1-10 show 4^{th} preferred embodiment that has the bulb shape light unit has bulb-base which-the current invention can acquire power from any bulb bases that are connected to an AC power source such as lamps, or bulb base adapters. The bulb base does not limit to one specification; any bulb bases (most commonly E12, E17, E26) can connect to the current invention. The said the current for different product housing design with preferred power terminal including prong, Bulb base, USB female ports so can be plugged in or USB wire connected in or-screwed in tightly to ensure the connectivity between the bulb base and the current this invention.

FIG. 2 and FIG. 2A shows The 3rd preferred embodiment of the current invention's optic elements has (1) The inner optic-elements is a reflector unit which has Plenty of small size different reflective optics lens build in on one piece of metalized treated reflector, the plenty of optics unit which has different size, shape, geometric shape, thickness, focus, reflective properties, refractive properties to make the LED(s) or Laser-light(s) light source light beam can traveling or passing to make the splendid and pre-designed light beam pattern, color, spread out, shape, brightness, and other light effects, performance, functions available from market place and may incorporate with motor/movement/spin/rotating/magnetic unit & coil assembly-to make the said optic-elements become moving optics-elements. From FIG. 2 and FIG. 2A shows the more than one optics-elements on the top of light source (LEDs and Laser-lights) the both light source light beam hit the center crystal-like optics ball, some light traveling and passing though the crystal-like optics ball basing on reflective or refraction theory so can create the very eye-catching light effects. The Both of optics-elements can cooperate with motor/moving/spin/rotating/magnetic unit & coil assembly to make optics-elements for moving-and moving at least one or both reflective lens and reflective-ball to get the desired light effects.

From FIG. 2 and FIG. 2A show the (2) preferred optics-elements has built-in plurality tiny reflective-lens of different size, shape, thickness, focus, color optics lens in one disc-shape reflector piece to make the LEDs or-and Laser-lights' light beam traveling or passing through to hit the others optic-element which has desire optics properties may in group combination select from optics lens, convex lens, concave lens, reflective lens, refractive lens, moving optic-element, element made by light-block material with holes, or opening or windows or cutouts or stencils, optic texture lens to make the light beam→1^{st} optic means→2^{nd} optics means (or to N optics means) to create the splendid light performance, effects, functions.

From FIG. 2A, It also appreciated that the more than one optics means and LEDs or/and Laser-lights has also incorporated with other electric parts & accessories may in group combination selected from power source, circuit, motor, movement, spin kit, rotating kit, magnetic unit & coin assembly, IC, sensor, controller or wireless controller, conductive piece, prong, Bulb base, USB set, circuit, and all other electric parts & accessories so can have right and pre-determined light function.

FIG. 2-1 and FIG. 2-2 and FIG. 2-3 and FIG. 2-4 and FIG. 2-5 shows the Second preferred embodiment which same as FIG. 1-A for moving optics-elements or moving light source which the said optics-elements (is not the optics-lens) has shaped openings, cutouts, holes, stencils, windows to allow the LEDs or/and Laser-light beam passing though the light-bock means' holes/opening/cutouts/stencils/windows and form the shaped lighted patterns and its light beam traveling (reflected) or passing though (refracted) by the top Wide angle view angle cover which has its preferred optics textures (plurality and variable focus of convex or concave small piece of lens to combine for one big as FIG. 2-1 big cover), thickness, convex or concave lens properties, reflective or refraction optics properties to has image, lighted patterns, message, time, geometric art, nature scene, galaxy, milky way, sky, cloud, starts, moon, water waves, animal, characters, cartoon, sign, logo, commercial to been seen. The second embodiment also may incorporate with motor/movement/spin/rotating/moving/magnetic unit & coil assembly to make the optics-element(s) or-and light source become moving type to make the motion light effects. This will increase more value for the said current invention.

FIG. 2-6 shows the second embodiment details construction.

From FIG. 2-6 Show the inner construction for one of preferred the light device has built-in motor (or equivalent motor as above listed all replaceable device) to fix the motor on the housing may by screw. It also shown the motor has optional gear-set (not shown) to reduce the motor's rotating speed to slower speed to prevent from people uncomfortable to see quickly moving image on ceiling, walls, floor. It also not show the switch, electric parts & accessories, conductive wires to connect with circuit and the get the power source constructions.

From FIG. 3-1 shows the Third preferred embodiment again has more than one of optics elements including top around 180 degree wide opening optic-lens cover which preferred has wave-like textures or plurality of small convex lens with different focus design big or small size mixed with variety of the thickness or-and refractive or-and reflective properties so has variable focus while the LEDs or/and laser-lights light beam hit the cover's some light beam will reflective and some light beam will refractive to viewer or desired areas.

For FIG. 3-1, The inner also has the 2^{nd} optics elements which may is a moving optic-elements connect with motor or magnetic unit & coil assembly to make shaving, waving, moving, motion of the said moving optic-elements so the light beam traveling or passing though the inner moving optics elements will make the LEDs or/and Laser-lights' light beam become changeable position, direction, orientation and hit the top cover's optic elements designs to come out more splendid light effects may be in any combination select from image, lighted patterns, message, time, geometric art, nature scene, galaxy, milky way, sky, cloud, starts, moon, water waves, animal, characters, cartoon, sign, logo, commercial to been seen.

From FIG. 3-2 shows the Third embodiment details construction.

FIG. 4-1 and FIG. 4-2 and FIG. 4-3 show the co-pending drawing for alternative design of Top cover optic-elements has plurality of reflective and refractive optics arrangement to form a one dome or sphere lens design so can make light source light beams to back and forth within the Top Cover in ball shape to make the light source light beam to spread out to get the image for wide range, big size but this also can apply and fall within the current scope of the invention. The current invention can has the half ball, ⅔ ball, sphere, to get desired wider area or big area has the lighted patterns though the top optic-elements only because the top optic-elements is consist of plurality and more than one of reflective or-and refractive lens use injection process to form one piece of the ball, ball like, sphere, half ball, ⅔ ball and incorporated with inside the LED(s) or-and Laser light source with predetermined color, number, brightness, IC, sequential, cycle, duration time, fade-in-N-fade out, pair flashing to get desired light effects. It also has the desired moving device which may selected from motor, spin kit, rotating kits, clock movement, timer, sensor, switch and get power source by prongs, bulb base, USB kits from AC or DC power source for plug-in wall outlet (female) by Prong (male) or insert into bulb socket (female) by Bulb base (male) or insert into USB port (Female) by USB Plug (male).

From co-pending filing, the alternative design for top cover with convex lens features also still fall within the current invention scope as (# ZZZ) (# ZZZ-I) (# ZZZ-II). FIG. 4 also Show the Light beam reflect within the more than one reflect-surface which on inner of the optics-lens which are in the shape of sphere. Also, the light beam pass though the outside convex-lens to project the image or lighted patterns to the ceilings, walls, floor. This embodiment teach (1) more than one reflect-surface inside of optics-lens and refract-surface outside the same optics lens (2) light project though the more than one optics-surface of same one piece of optic-lens which the inner side is a flat mirror-polished reflector and outside is convex-shape lens so it is built 2 kind of optics-properties in one optics-lens (3) each reflective and refractive lens get together to form a semi-sphere geometric shape outer optics-lens. (4) 2 half-sphere ball or ⅔ ball or dome or sphere are preferred designs.

FIG. 4-1: Show the other viewing angle for the ⅔ ball shape optic-lens has both reflective and refractive optics properties and base to form the LED or-and Laser light device which has more than one optics-properties. The ⅔ ball outer cover has more than one reflect-and refract lens. This is different with inventor's earlier U.S. Pat. No. 7,632,004 LED night light has more than one optics means. U.S. Pat. No. 8,277,087 has more than one reflect means. U.S. Pat. No. 7,455,444 LED night light has more than one LED. U.S. Pat. No. 8,434,927 interchange power source for current invention scope. Because Co-inventor prior art show is 2 separated piece not built-in one piece of optics-lens but still can be explain is continue filing for optics arrangement.

From FIG. 4-2: Show the inner side of the other shape optical-lens which has more than one reflective surfaces inside of optics-lens so can overcome LED's narrow light beam angle. The current invention all LED or-and laser light source has different direction to emit the light beam after go through multiple inner reflect-surface even the light angle is narrow it is not a problem because the light emit from LED or-and laser light source's head will hit the 1st reflect-surface, then hit to 2nd, 3rd, 4th . . . reflect-surface(s) till the light beam been pass though outside multiple convex-surface of the ball-like outer optics-lens so this is current features too! Add motor can make the image be rotating to get moving image to viewer. The construction.

ow the co-pending drawing for alternative design of Top cover optic-lens has plurality of reflective and refractive optics-surface(s) design built-in inner and outside of the cover optics-lens, so can make light source light beams to back and forth within the Top Cover inner of the ball-like shape to make the light source light beam to spread out to get the image for wide range, big size but this also can apply and fall within the current scope of the invention.

In the preferred embodiments, images are created based on the relationship between the first optics-element(s) and the second optics-element(s) or all other optics-element(s). The light device can employ any kind of design, shape, display, or geometric arrangement of the more than one optics-elements to create big size or large image to cover Big area for special light effects though the Big or wider opening of the Top cover with desired reflective or refractive lens assembly.

Although specific preferred embodiments of the current invention are described above, it is to be appreciated that all alternative, equivalent, same-function and/or same-skill-or-theory variations, modifications, replacements, arrangements, or constructions may still fall within the current scope of the invention.

I claim:

1. An LED or/and Laser light device having more than one optics element(s) to create wider range or big viewing angle of image or-and lighted patterns comprising:
at least one LED or/and Laser light units;
more than one of optics element(s) has geometric shape and each has reflective or refractive properties and The light beam emit from LEDs or/and Laser-light(s) source(s) traveling or passing though the 1st optics element(s) and hit to others more than one optic element(s) to create a wider range or bigger size of image, message, time, geometric art, nature scene, galaxy, milky way, sky, cloud, nebula, stars, moon, water waves, aurora light, animal, characters, cartoon, sign, logo, commercial been viewing and project to surrounding surface(s) including ceiling, walls, other surfaces(es).
The LEDs or/and Laser lights source(s) can be selected from any combination of brightness, single color, multiple color, multiple piece, standard, and special LEDs or/and Laser lights assemblies, LED or-and laser lights number from 1 to N (N can be any number) to arrange in desire matrix, combination has the predesigned spacing or distance, position, orientation, high and lower position, to get desired light effects which may select from available items from the market.
The LEDs or laser lights source(s) are preferably connected with parts & accessories in any combination from circuit, power source, prong, bulb-base, USB related kits to get power, battery power, DC power source, AC power source, contactor(s), connector(s), conductive unit(s), prongs for outlets to get power, bulb base to insert into bulb receiving socket to get power, switch, sensor, motor, spin, rotating, magnetic-coil and magnetic assembly, gear set, speed controller, printed circuit unit(s), integrated circuit (I.C.) and/or related parts and accessories to cause the LED or-and laser light source(s) to turn on and off according to a predetermined time period, functions, colors, brightness, duration, cycles and-or effects to provide a desired lighting performance.
Wherein said the optic elements is at least one of optics-elements including optics-lens which has at least one of different thickness, textures, waved surface, variable thickness, reflector, multiple small reflective surface reflector, reflective surface, reflective unit, refractive unit, concave lens, convex lens,
or optic-element is one of the non-optics-lens including film, slide, laser film, hologram film, grating film, image forming kits, stencil unit(s), light block material with opening, shape windows, cutouts, stencil treated.
wherein said at least one LED or/and laser light source(s) connected to a power source by conductor unit(s) and circuitry including kits for causing said at least one LED or/Laser light to turn on and off for a predetermined period to provide predetermined functions, colors, and effects.
The said LED or/and laser light source(s) emit light beam traveling or passing though the at least one of optics element(s) and at least one is optic-lens for bulb top cover has reflection or-and refraction or more than one optics properties on desired surface(s) of LED bulb top cover's optic-lens.
The improvement including: Wherein, the said LED or-and laser light is (1) a plug-in Outlets device or (2) has bulb-base device which connect with bulb-receiving socket or (3) has USB kits to connect with the power source, but not electric wired products.

2. An LED or/and laser light device as recited in claim 1, wherein said optics element(s) is selected from the group consisting of a reflector, chrome-finished piece, fine-polished piece, and multiple-reflective surface(s) reflector, or optics lens on variety selections, elements made of light block material has shaped opening or cutouts or holes or windows or stencil, any reflective or refractive optics lens, related parts and/or accessories to make light beams traveling, passing, or reflect, or refract by said these kits to make the desired display with steady or moving effects of the image or the said lighted patterns as pre-determined effects, performance, functions.

3. An LED or/and laser light device as recited in claim 1, wherein said optics element(s) may in group combination selected from (1) Optic lens has textures (2) Optics element made by non-optics lens material has shape holes, opening, cutouts, window, stencil (3) Optics lens or elements is moving while incorporate with crane shift, motor, spin kit, rotating kit, movement, Magnetic unit & coil kits (4) Optics lens has plurality tiny different shape, size, color, thickness, variable thickness reflective-surface arranged in one piece of optics-lens to get fixed LEDs or-and Laser-light light beam to become very splendid and spread out light beam (5) Optic Lens for Cover which has around 180 degree flat wide opening or wider ½ or ⅔ ball, dome, sphere shape so can cover arc opening to make all light beams to spread out to wider and Bigger areas to create designed Image wanted (6) Optics Lens or element can be any shape such as sheet, piece, ball, half ball, ⅔ ball, sphere, bar, cover or any Other geometric shape with its preferred optic construction including texture, opening, Window, convex lens, magnify lens, variable thickness, variable focus by plurality of tiny optic element, reflective kits, refraction kits has steady fixed or moving, waving, shaking, vibration, rotating added features.

4. An LED or/and laser light device as recited in claim 1, wherein said power is get through or by an outlet, connector, conductor, bulb base, USB kits from power source selected from AC outlet, bulb socket, batteries, DC power source, solar power source, chemical power source, and wind power source or market available energy to provide electricity though related circuit to drive said at least one LED or-and Laser Light(s) source(s) to emit light beams.

5. An LED or/and laser light device as recited in claim 1, wherein additional motor/spin/movement/motion/magnetic & coil assembly, and gear set fit within the LED or/and Laser light device to make or create or project the moving image(s) message, time, geometric art, nature scene, galaxy, milky way, sky, cloud, stars, moon, water waves, animal, characters, cartoon, sign, logo, commercial has pre-determined functions, effects, performance for wide range or space or area has these light effects to be seen.

6. An LED or-and laser light device as recited in claim 1, wherein said at least one LED or-and Laser Light source selected from a single or multiple color, multiple pieces, a standard unit, and a custom made assembly, more than one light source, more than one colors, more than one wattage of Laser light output.

7. An LED or/and laser light device as recited in claim 1, wherein said the device or the products can emit or projection light beams is one of (1) products for plug-in outlets which located on Wall, receptacles, extension cord, Power strip to get power, or (2) products for cigarette light plug, or (3) product has USB female ports to accept power by USB male plug, or (4) Product has bulb-base to put into female bulb receiving socket to get power.

8. An LED or/and laser light device as recited in claim 1, wherein said the geometric optics-element(s) or optics-lens has desire combination selected from the (a) passing though lens, (b) reflective lens, (c) refractive lens, (d) convex lens, (e) concave lens, (f) laser film, (g) hologram film, or (h) lens with preferred texture or polish finish surface or thickness or curvature or plurality of different thickness or different focus or plurality of tiny optics properties pieces to combination in one piece or-and the inner or outside surface or-and all sides of the optics lens or element surface(s) has its own certain optics property.

9. An LED or/and laser light device having more than one optics element(s) to create Wider Viewing Angle or range image comprising:
at least one LED or/and Laser Light;
at least one or more than one of optics element(s) has geometric shape and the desired surface has at least one reflective or-and refractive property, or pre-designed optics-properties;
and The said reflective or refractive properties having a reflecting or refractive surface for reflecting or refractive light from the said LED(s) or-and laser lights source(es).
The said at least one or more than one optic-elements has more than one of light beam traveling or passing through to create a wider range or bigger size of image, lighted patterns, lighted shape light, message, time, geometric art, nature scene, galaxy, nebula, cloud, milky way, sky, cloud, stars, moon, water waves, aurora light, animal, characters, cartoon, sign, logo, commercial message been viewing and create or project to surface(s) including ceiling, walls, other surfaces(es) while the device is connect power source by prongs or bulb-base or USB kits or conductive piece including plug-into all kind of outlets or plug-into extension cords or connect with the power source by bulb-base, by USB plug & ports.
The LEDs or laser lights can be selected from any combination of single color, multiple color, multiple piece, standard, and special light source assemblies, light source number from 1 to N (N can be any number) to arrange in desire matrix and arrangement has preferred spacing, distance, orientation for all light sources.
The LEDs or laser lights are preferably connected with parts & accessories in any combination from circuit, power, prong, bulb base, USB kits, battery, AC power, contactors, conductive kits, switch, sensor, motor, spin, rotating, movement, magnetic-coil and magnetic kits, gear set, speed controller, printed circuit, integrated circuit (I.C.) and/or related parts and accessories to cause the LEDs or Laser lights source(es) to turn on and off according to a predetermined time period, functions, colors, duration and/or effects to provide a desired lighting performance.
The said optics elements at least one is optics-lens, film, slide, laser film, hologram film, grating film, image forming kits, stencil, block material with opening or shape windows or cutouts or silkscreen piece, optics-lens has different thickness or textures or waved surface or variable thickness or many tiny reflectors, multiple small reflective-lens on desired surface of optics-element, refractive lens, reflective unit, refractive unit, concave lens, convex lens to allow the light beam to pass though or travel within to make desired light image or lighted patterns.
wherein said at least one LED or-and laser light are connected to a power source by conductors and circuitry including system for causing said at least one light sources to turn on and off for a predetermined period to provide predetermined functions, colors, and effects.
The said LED and laser light device the said light source(s) emit light beam traveling or passing though the at least one of optics element(s) and at least one is top cover optics lens which the surface has at least has one of reflective or-and refractive properties.
The improvement including:
Wherein, the said light device has no any motor to make the said changeable image, message, time, geometric art, nature scene, galaxy, milky way, sky, cloud, stars, moon, water waves, aurora light, animal, characters, cartoon, sign, logo, commercial to been seen.
Wherein, the all moving effects are made by plurality of LED or-and laser lights' sequential flashing, fade-in and fade-out, color changing, sequential, random, or other LED light performance, effects, performance, duration and use the each LED with time difference, duration, on-off duty, cycles to turn on and turn off on different time and location and orientation to make the viewing image to looking like moving.

10. An LED or/and laser light device having more than one optics element(s) to create Wider Viewing Angle or range or size of image or lighted patterns comprising:
at least one LED or/and Laser light;
at least one or more than one of optics element(s) has geometric shape has more than one reflective or-and refractive properties, preferred optics-properties;
and The said reflective or refractive properties having a reflecting or refractive surface for reflecting or refractive light from the said LED or LEDs or laser lights.
The said at least one or more than one optic-elements also has more than one of light beam traveling or passing through to create a wider range image, lighted patterns, shaped lighted patterns, message, time, geometric art, nature scene, galaxy, milky way, sky, cloud, stars, moon, water waves, aurora light, animal, characters, cartoon, sign, logo, commercial sign been viewing and create or project to surrounding surface(s) including ceiling, walls, other surfaces(es) while the device prong to plug-into all kind of outlets or plug into extension cords or connect with the power source by prong, bulb-base, USB wire.
The LEDs and Laser Light can be selected from any combination of brightness, single color, multiple color, multiple piece, standard, and special light sources assemblies, light sources number from 1 to N (N can be any number) to arrange in desire matrix or arrangement has desired spacing, distance, position, orientation.
The LED or laser Light are preferably connected with parts & accessories in any combination from circuit, power source, prongs, USB wire, battery, AC power, contact unit, conductive unit, switch, sensor, motor, spin kits, rotating kits, magnetic-coil and magnetic set, gear set, speed controller, stencil, block material with shaped opening, windows, cutouts, holes, stencils, or printed circuit, integrated circuit (I.C.) and/or related parts and accessories to cause the LED or laser light or any combination light source to turn on and off according to a predetermined time period, functions, colors, and/or effects to provide a desired lighting performance.
wherein said at least one of light sources are connected to a power source by conductor kits and circuitry including system for causing said at least one of light source to turn on and off for a predetermined period time to provide predetermined functions, colors, and effects.
The improvement including: The said LED or/and laser light create or project image, lighted patterns, shape lighted patterns, geometric art, nature scene, galaxy, nebula, milky way, sky, cloud, stars, moon, water waves, aurora light, animal, characters, cartoon, sign, logo, commercial text from light source(s) emit light beam traveling or passing though the at least one or more than one moving optics-elements which light beams passing though the moving optic-element(s) drive by motor, or spin set, or rotating kits, or magnetic & magnetic coil set, movement kits or desired combinations.
Wherein, the said moving optics element(s) made of light block-out material with shaped opening, cutouts, windows, stencil, film, slide, image forming set, display kits, displayer, or The moving optics lens has its preferred optical texture or desired shape has variety or plurality of different thickness, wave texture, reflective or-and refractive properties to allow light passing though so create desired changeable or moving effect's lighted patterns, shaped lighted patterns, image, message, time, geometric art, nature scene, galaxy, milky way, sky, cloud, stars, moon, water waves, aurora light, animal, characters, cartoon, sign, logo, commercial to been seen.
The said device is Plug-in outlet device or is a device has bulb-base, or a device has USB kits so device can connect the power source by prong or by bulb-base or by USB plug & ports by wire.

11. An LED or/and laser light device having more than one optics element(s) to create Wider Viewing Angle or range or size of image or lighted patterns comprising:
At least two of optics-elements the 1^{st} one is optic-lens has reflective or-and refractive optics property for top cover which has around 180 degree opening or half ball or ⅔ ball or big arc sphere or dome shape for top cover which make the light beam to spread out to big area to be seen.
The 2nd of two other optics-element also is optics lens to make the inner LED or-and Laser light source majority light beam to hit the 2^{nd} optic-lens which has desired lens treated or has reflective or-and refractive properties so can make desired lighted patterns.

12. An LED or/and laser light device having more than one optics element(s) to create Wider Viewing Angle or range or size of image or lighted patterns comprising:
At least two of optics-elements the 1^{st} one is optic-lens has reflective or-and refractive optics property for top cover which has around 180 degree opening or half ball or ⅔ ball or big arc sphere or dome shape for top cover which make the light beam to spread out to big area to be seen.
The 2nd of two other optics-element is not optics-lens and made by light block material which has desired treatment on its surface including stencil, cutout, opening, image forming display, full color slide, film, shaped openings, printed film, plastic sheet with arts to make the inner LEDs or-and laser light beam to passing through to form the desired colorful, shaped, character, image, lighted pattern, cartoon, galaxy, nebura with desired number, color, brightness, IC program to make the pre-determined light effects.
The said 2nd optics-elements incorporated with the said motor, moving device, spin unit, rotating unit, clock movement, inductive magnetic & coil assembly with related parts and accessories can make the said image, lighted patterns, sign, art, shape design become moving effects with desired IC program.

13. 11. An LED or/and laser light device having more than one optics element(s) to create Wider Viewing Angle or range or size of image or lighted patterns comprising:
At least three of optics-elements the 1^{st} one is optic-lens has reflective or-and refractive optics property for top cover which has around 180 degree opening or half ball or ⅔ ball or big arc sphere or dome shape for top cover which make the light beam to spread out to big area to be seen.
The 2nd of two other optics-element also is optics-lens in the form or nuts, ball, multiple sides, hexagon, or other geometric shape which has multiple small surface to form the nuts or ball or geometric shape which to make the inner LED or-and Laser light source majority light beam to hit the 2^{nd} optic-lens which has reflective or-and refractive properties so can make spot light beam to become hundred or thousand light beam to spread out and hit the 3^{rd} optics-elements.
The 3^{rd} of the optic-element is in the form of disc or dish-like reflectors which has plurality of small and tiny reflective-unit on the reflector's surface and to collect light beam came out from 2^{nd} optic-lens to wider to all direction with splendid plurality of light beams to passing thought the top cover 1^{st} optics-lens.
The said 2^{nd} reflective or-and refractive connect with motor or moving device can create the moving light effects and all light beam emit from moving 2^{nd} surface to the 3^{rd} reflector surface of disc or dish shape. It come out the moving splendid light effects while incorporated the multiple color LEDs or-and laser beam.

14. An LED or/and laser light device having more than one optics element(s) to create Wider Viewing Angle or range or size of image or lighted patterns comprising:
At least three of optics-elements the 1^{st} one is optic-lens has reflective or-and refractive optics property for top cover which has around 180 degree opening or half ball or ⅔ ball or big arc sphere or dome shape for top cover which make the light beam to spread out to big area to be seen.
The other 2^{nd} or 3^{rd} or more optics-elements can be desired combination for (1) optics lens (2) light block material optic-element has image forming treatment, or shape forming display (3) Nuts or ball shaped optics-elements and surface has multiple treated tiny optic-surfaces (4) laser treated lens or film (5) Hologram or grating film (6) moving and changeable Digital data display or LCD display to arrange to put in front of the colorful light beams came from multiple piece of LED or-and laser light source to make desired effects.
